(19) United States
(12) Patent Application Publication
(10) Pub. No.: US 2024/0320384 A1
(43) Pub. Date: Sep. 26, 2024

(54) OPTIMIZATION ANALYSIS METHOD, APPARATUS, AND PROGRAM FOR JOINING POSITIONS OF AUTOMOTIVE BODY

(71) Applicant: JFE STEEL CORPORATION, Tokyo (JP)

(72) Inventors: Yuichi TOKITA, Tokyo (JP); Tsuyoshi SHIOZAKI, Tokyo (JP)

(73) Assignee: JFE STEEL CORPORATION, Tokyo (JP)

(21) Appl. No.: 18/274,533

(22) PCT Filed: Nov. 1, 2021
(86) PCT No.: PCT/JP2021/040251

§ 371 Date: Jul. 27, 2023

(30) Foreign Application Priority Data
Jan. 27, 2021 (JP) 2021-010836
Sep. 17, 2021 (JP) 2021-151704

(51) Int. Cl. G06F 30/15; B62D 65/02

(52) U.S. Cl. CPC G06F 30/15; B62D 65/02

(57) ABSTRACT

An optimization analysis method for joining positions of an automotive body includes setting the whole or part of an automotive body model as an analysis object model, generating an optimization analysis model by densely setting joining candidate points to the analysis object model, setting a variable loading condition, setting a reciprocal of a predetermined target fatigue life as a target liner cumulative damage, setting improvement of stiffness of the optimization analysis model, reduction of liner cumulative damage that is a reciprocal of fatigue life of joining candidate points, and minimization of the number of joining candidate points, as optimization analysis conditions, and performing optimization analysis by applying the variable loading condition to the optimization analysis model to obtain optimal arrangement of the joining points that achieves the optimization analysis conditions.

### FIELD

The present invention relates to an optimization analysis method, apparatus, and program for joining positions of an automotive body, and more particularly, to an optimization analysis method, apparatus, and program for joining positions of an automotive body that obtain optimal positions for joining points to improve both of the stiffness of an automotive body of an automobile and fatigue life at the joining points in the automotive body to which a parts assembly is joined.

### BACKGROUND

In recent years, weight reduction of automotive bodies due to environmental problems has been promoted particularly in automobile industry, and analysis by computer aided engineering (hereinafter, referred to as “CAE analysis”) is an essential technology for automotive body design. In this CAE analysis, it is known that improvement of stiffness and weight reduction are achieved by using optimization technologies such as mathematical optimization, sheet thickness optimization, shape optimization, and topology optimization.

A structural body such as an automotive body is formed by joining a plurality of parts as a parts assembly by welding or the like, and it is known that the stiffness of the entire automotive body and the fatigue life of a joining point are improved if an amount of joining at a portion joined as the parts assembly (e.g., if the number of joining points formed by spot welding is increased). However, from the viewpoint of the manufacturing cost of the automotive body, it is desirable to reduce the amount of joining as much as possible.

Therefore, in order to improve the stiffness of the automotive body and the fatigue life of the joining point while suppressing the manufacturing cost of the automotive body, a method of determining a joining position by experience, intuition, or the like and a method of determining a portion having large stress as the joining position by stress analysis, are provided, as a method of obtaining the joining position (welding position of a spot welding point or the like) where the parts are joined to each other.

However, the method of determining the joining position by experience, intuition, or the like does not provide the position of the joining point that is necessary for improving both the stiffness and the fatigue life, and therefore, in some cases, a position unnecessary for improving the stiffness and fatigue life may be obtained as the joining point, and it must be said that efficiency is poor in terms of cost due to a process of trial and error.

In addition, the method using the stress analysis to increase the number of joining points around the joining position having large stress provides a change in the stiffness and fatigue life as compared with those before obtaining the joining position by the method, but the stiffness and fatigue life of the other portions are often relatively reduced although the stiffness and fatigue life of only in the vicinity of the joining position are improved, and in evaluation of the entire automotive body, the joining position obtained by this method is not necessarily optimal.

In addition, when the position of the joining point formed by spot welding is obtained by the above methods, if the positions of the adjacent joining points are too close to each other, a welding current (current shunt) flows through an adjacent joining point previously welded, and a sufficient current does not flow through a joining point to be spot-welded next, resulting in poor welding.

Therefore, Patent Literature 1 discloses a method of obtaining optimal positions of the joining points formed by spot welding by using optimization technology.

### CITATION LIST

### Patent Literature

Patent Literature 1: JP 2013-025593 A

### SUMMARY

### Technical Problem

However, the method disclosed in Patent Literature 1 is provided to improve stiffness while minimizing the number of joining points, but no consideration is given to improvement of the fatigue life of the joining points formed by spot welding. Therefore, there has been a demand for a technology for obtaining the optimal positions of the joining points by which the number of joining points can be minimized while improving the stiffness of the automotive body and fatigue life of the joining points.

In addition, during traveling of the automobile, a variable amplitude load having an amplitude, direction, and the like not temporally constant but changing complexly is input to the automotive body. Therefore, there has been a demand for a technology for obtaining the optimal positions of the joining points by which the stiffness of the automotive body and fatigue life of the joining points can be improved when a complicated variable amplitude load is input to the automotive body.

The present invention has been made to solve the above problems, and an object of the present invention is to provide an optimization analysis method, apparatus, and program for joining positions of an automotive body that obtain optimal positions for joining points to minimize the number of the joining points while improving both of the stiffness of an automotive body of an automobile and fatigue life of the joining points in the automotive body at which a parts assembly is joined, upon input of variable amplitude load to the automotive body of the automobile.

### Solution to Problem

An optimization analysis method according to the present invention for joining positions of an automotive body for performing optimization analysis for optimal arrangement of joining points in order to achieve any of improvement of stiffness of an automotive body model, improvement of fatigue life of the joining points of the automotive body model at which parts assembly is joined, and minimization of number of the joining points, through performance of the following steps by a computer, for the whole or part of the automotive body model of an automobile including a plurality of part models including a beam element, a two-dimensional element, and/or a three-dimensional element and having initial joining points at which the plurality of part models as the parts assembly is joined, includes: an analysis object model setting step of setting a whole or part of the automotive body model as an analysis object model; an optimization analysis model generation step of generating an optimization analysis model by densely setting all joining candidate points being candidates for the joining points optimally arranged, to the analysis object model; a variable loading condition setting step of setting a variable loading condition by dividing a variable amplitude load applied to the optimization analysis model into loading conditions of a plurality of different vibration patterns, combining the predetermined numbers of cycles of the respective loading conditions of the respective vibration patterns, and forming one sequence; a target fatigue life setting step of setting a target fatigue life of the optimization analysis model as number of sequences of the variable loading condition; an optimization analysis condition setting step of obtaining number of cycles to failure of each of the joining candidate points for each of the loading conditions of the vibration patterns, obtaining the sum of ratios between the number of cycles and the number of cycles to failure of the loading condition of each vibration pattern as much as the number of sequences of the variable loading condition set in the target fatigue life setting step, as liner cumulative damage of each of the joining candidate points, and setting a condition about the liner cumulative damage of the joining candidate points to be left after optimization analysis, a condition about stiffness of the optimization analysis model, and a condition about number of joining candidate points to be left after optimization analysis, as objective functions or constraints that are optimization analysis conditions, in order to perform optimization analysis for the optimization analysis model; and an optimization analysis step of applying the variable loading condition set in the variable loading condition setting step to the optimization analysis model, performing optimization analysis under the optimization analysis conditions, and obtaining, as the optimal arrangement of the joining points, arrangement of the joining candidate points to achieve any of reduction of the liner cumulative damage of the joining candidate points, improvement of the stiffness of the optimization analysis model, and minimization of the number of the joining candidate points to be left.

In the optimization analysis step, topology optimization based on densimetry may be performed, and discretization may be performed by setting a penalty coefficient to 4 or more in the topology optimization.

An optimization analysis method according to the present invention for joining positions of an automotive body for performing optimization analysis for optimal arrangement of joining points in order to achieve any of improvement of stiffness of an automotive body model, improvement of fatigue life of the joining points of the automotive body model at which parts assembly is joined, and minimization of number of the joining points, through performance of the following steps by a computer, for the whole or part of the automotive body model of an automobile including a plurality of part models including a beam element, a two-dimensional element, and/or a three-dimensional element and having initial joining points at which the plurality of part models as the parts assembly is joined, includes: an analysis object model setting step of setting the whole or part of the automotive body model as an analysis object model; an optimization analysis model generation step of generating an optimization analysis model by densely setting all joining candidate points being candidates for the joining points optimally arranged, to the analysis object model; a variable loading condition setting step of setting a variable loading condition by dividing a variable amplitude load applied to the optimization analysis model into loading conditions of a plurality of different vibration patterns, combining the predetermined numbers of cycles of the respective loading conditions of the respective vibration patterns, and forming one sequence; a target fatigue life setting step of setting a target fatigue life of the optimization analysis model as number of sequences of the variable loading condition; an optimization analysis condition setting step of obtaining number of cycles to failure of each of the joining candidate points for each of the loading conditions of the vibration patterns, obtaining the sum of ratios between the number of cycles and the number of cycles to failure of the loading condition of each vibration pattern as much as the number of sequences of the variable loading condition set in the target fatigue life setting step, as liner cumulative damage of each of the joining candidate points, and setting a condition about the liner cumulative damage of the joining candidate points to be left after optimization analysis, a condition about stiffness of the optimization analysis model, and a condition about number of joining candidate points to be left after optimization analysis, as objective functions or constraints that are optimization analysis conditions, in order to perform optimization analysis for the optimization analysis model; an optimization analysis step of applying the variable loading condition set in the variable loading condition setting step to the optimization analysis model, performing optimization analysis under the optimization analysis conditions, and leaving, as the temporary optimal arrangement of the joining points, arrangement of the joining candidate points to achieve any of reduction of the liner cumulative damage of the joining candidate points, improvement of the stiffness of the optimization analysis model, and minimization of the number of the joining candidate points to be left; a generation step for analysis object model with joining candidate points selected and set of selecting predetermined number of joining candidate points from among the joining candidate points remaining as the temporary optimal arrangement after the optimization analysis, setting the selected joining candidate points to the analysis object model instead of the initial joining points, and generating an analysis object model with joining candidate points selected and set; a performance calculation step for selected joining candidate points of performing stress analysis by applying the loading condition of each vibration pattern in the variable loading condition, and the constraint condition, which are set in the variable loading condition setting step, to the analysis object model with joining candidate points selected and set, and using a result of the stress analysis to calculate the fatigue life of the selected joining candidate points under the variable loading condition and the stiffness of the analysis object model with joining candidate points selected and set; a determination step of determining whether the fatigue life of the joining candidate points under the variable loading condition in the analysis object model with joining candidate points selected and set, and the stiffness of the analysis object model with joining candidate points selected and set satisfy predetermined performance exceeding that of the analysis object model to which the initial joining points are set; and an optimal joining point determination step of determining arrangement of the selected joining candidate points as optimal arrangement of the joining points when it is determined that the predetermined performance is satisfied in the determination step, and changing the condition about the liner cumulative damage of the joining candidate points to be left after optimization analysis, the condition about the stiffness of the optimization analysis model, or the condition about the number of joining candidate points to be left after the optimization analysis set in the optimization analysis condition setting step until the predetermined performance is satisfied, when it is determined that the predetermined performance is not satisfied in the determination step, repeating the optimization analysis step, the generation step for analysis object model with joining candidate points selected and set, the performance calculation step for selected joining candidate points, and the determination step, and determining the arrangement of the joining candidate points selected when the predetermined performance is satisfied, as the optimal arrangement of the joining points.

An optimization analysis apparatus according to the present invention for joining positions of an automotive body, the apparatus performing optimization analysis to obtain optimal arrangement of joining points to achieve any of improvement of stiffness of an automotive body model, improvement of fatigue life of the joining points of the automotive body model at which parts assembly is joined, and minimization of number of the joining points, for the whole or part of the automotive body model of an automobile including a plurality of part models including a beam element, a two-dimensional element, and/or a three-dimensional element and having initial joining points at which the plurality of part models are joined as the parts assembly, includes: an analysis object model setting unit that sets the whole or part of the automotive body model as an analysis object model; an optimization analysis model generation unit that generates an optimization analysis model by densely setting all joining candidate points being candidates for the joining points optimally arranged, to the analysis object model; a variable loading condition setting unit that sets a variable loading condition by dividing a variable amplitude load applied to the optimization analysis model into loading conditions of a plurality of different vibration patterns, combines the predetermined numbers of cycles of the respective loading conditions of the respective vibration patterns, and forms one sequence; a target fatigue life setting unit that sets a target fatigue life of the optimization analysis model as number of sequences of the variable loading condition; an optimization analysis condition setting unit that obtains number of cycles to failure of each of the joining candidate points for each of the loading conditions of the vibration patterns, obtains the sum of ratios between the number of cycles and the number of cycles to failure of the loading condition of each vibration pattern as much as the number of sequences of the variable loading condition set in the target fatigue life setting unit, as liner cumulative damage of each of the joining candidate points, and sets a condition about the liner cumulative damage of the joining candidate points to be left after optimization analysis, a condition about stiffness of the optimization analysis model, and a condition about number of joining candidate points to be left after optimization analysis, as objective functions or constraints that are optimization analysis conditions, in order to perform optimization analysis for the optimization analysis model; and an optimization analysis unit that applies the variable loading condition set in the variable loading condition setting unit to the optimization analysis model, performs optimization analysis under the optimization analysis conditions, and obtains, as the optimal arrangement of the joining points, arrangement of the joining candidate points to achieve any of reduction of the liner cumulative damage of the joining candidate points, improvement of the stiffness of the optimization analysis model, and minimization of the number of the joining candidate points to be left.

The optimization analysis unit may perform topology optimization based on densimetry, and perform discretization by setting a penalty coefficient to 4 or more in the topology optimization.

An optimization analysis apparatus according to the present invention for joining positions of an automotive body, the apparatus performing optimization analysis to obtain optimal arrangement of joining points to achieve any of improvement of stiffness of an automotive body model, improvement of fatigue life of the joining points of the automotive body model at which parts assembly is joined, and minimization of number of the joining points, for the whole or part of the automotive body model of an automobile including a plurality of part models including a beam element, a two-dimensional element, and/or a three-dimensional element and having initial joining points at which the plurality of part models are joined as the parts assembly, includes: an analysis object model setting unit that sets the whole or part of the automotive body model as an analysis object model; an optimization analysis model generation unit that generates an optimization analysis model by densely setting all joining candidate points being candidates for the joining points optimally arranged, to the analysis object model; a variable loading condition setting unit that sets a variable loading condition by dividing a variable amplitude load applied to the optimization analysis model into loading conditions of a plurality of different vibration patterns, combines the predetermined numbers of cycles of the respective loading conditions of the respective vibration patterns, and forms one sequence; a target fatigue life setting unit that sets a target fatigue life of the optimization analysis model as number of sequences of the variable loading condition; an optimization analysis condition setting unit that obtains number of cycles to failure of each of the joining candidate points for each of the loading conditions of the vibration patterns, obtains the sum of ratios between the number of cycles and the number of cycles to failure of the loading condition of each vibration pattern as much as the number of sequences of the variable loading condition set in the target fatigue life setting unit, as liner cumulative damage of each of the joining candidate points, and sets a condition about the liner cumulative damage of the joining candidate points to be left after optimization analysis, a condition about stiffness of the optimization analysis model, and a condition about number of joining candidate points to be left after optimization analysis, as objective functions or constraints that are optimization analysis conditions; an optimization analysis unit that applies the variable loading condition set in the variable loading condition setting unit to the optimization analysis model, performs optimization analysis under the optimization analysis conditions, and leaves, as the temporary optimal arrangement of the joining points, arrangement of the joining candidate points to achieve any of reduction of the liner cumulative damage of the joining candidate points, improvement of the stiffness of the optimization analysis model, and minimization of the number of the joining candidate points to be left; a generation unit for analysis object model with joining candidate points selected and set that selects a predetermined number of joining candidate points from among the joining candidate points remaining as the temporary optimal arrangement after the optimization analysis, sets the selected joining candidate points to the analysis object model instead of the initial joining points, and generates an analysis object model with joining candidate points selected and set; a performance calculation unit for selected joining candidate points that performs stress analysis by applying the loading condition of each vibration pattern in the variable loading condition, and the constraint condition, which are set in the variable loading condition setting unit, to the analysis object model with joining candidate points selected and set, and uses a result of the stress analysis to calculate the fatigue life of the selected joining candidate points under the variable loading condition and the stiffness of the analysis object model with joining candidate points selected and set; a determination unit that determines whether the fatigue life of the joining candidate points under the variable loading condition in the analysis object model with joining candidate points selected and set, and the stiffness of the analysis object model with joining candidate points selected and set satisfy predetermined performance exceeding that of the analysis object model to which the initial joining points are set; and an optimal joining point determination unit that determines arrangement of the selected joining candidate points as optimal arrangement of the joining points when it is determined that the predetermined performance is satisfied by the determination unit, and changes the condition about the liner cumulative damage of the joining candidate points to be left after optimization analysis, the condition about the stiffness of the optimization analysis model, or the condition about the number of joining candidate points to be left after the optimization analysis set in the optimization analysis condition setting unit until the predetermined performance is satisfied, when it is determined that the predetermined performance is not satisfied by the determination unit, repeats processing by the optimization analysis unit, the generation unit for analysis object model with joining candidate points selected and set, the performance calculation unit for selected joining candidate points, and the determination unit, and determines the arrangement of the joining candidate points selected when the predetermined performance is satisfied, as the optimal arrangement of the joining points.

An optimization analysis program according to the present invention for joining positions of an automotive body, the program performing optimization analysis to obtain optimal arrangement of joining points to achieve any of improvement of stiffness of an automotive body model, improvement of fatigue life of the joining points of the automotive body model at which parts assembly is joined, and minimization of number of the joining points, for the whole or part of the automotive body model of an automobile including a plurality of part models including a beam element, a two-dimensional element, and/or a three-dimensional element and having initial joining points at which the plurality of part models are joined as the parts assembly, causes a computer to execute as: an analysis object model setting unit that sets the whole or part of the automotive body model as an analysis object model; an optimization analysis model generation unit that generates an optimization analysis model by densely setting all joining candidate points being candidates for the joining points optimally arranged, to the analysis object model; a variable loading condition setting unit that sets a variable loading condition by dividing a variable amplitude load applied to the optimization analysis model into loading conditions of a plurality of different vibration patterns, combines the predetermined numbers of cycles of the respective loading conditions of the respective vibration patterns, and forms one sequence; a target fatigue life setting unit that sets a target fatigue life of the optimization analysis model as number of sequences of the variable loading condition; an optimization analysis condition setting unit that obtains number of cycles to failure of each of the joining candidate points for each of the loading conditions of the vibration patterns, obtains the sum of ratios between the number of cycles and the number of cycles to failure of the loading condition of each vibration pattern as much as the number of sequences of the variable loading condition set in the target fatigue life setting unit, as liner cumulative damage of each of the joining candidate points, and sets a condition about the liner cumulative damage of the joining candidate points to be left after optimization analysis, a condition about stiffness of the optimization analysis model, and a condition about number of joining candidate points to be left after optimization analysis, as objective functions or constraints that are optimization analysis conditions, in order to perform optimization analysis for the optimization analysis model; and an optimization analysis unit that applies the variable loading condition set in the variable loading condition setting unit to the optimization analysis model, performs optimization analysis under the optimization analysis conditions, and obtains, as the optimal arrangement of the joining points, arrangement of the joining candidate points to achieve any of reduction of the liner cumulative damage of the joining candidate points, improvement of the stiffness of the optimization analysis model, and minimization of the number of the joining candidate points to be left.

The optimization analysis unit may perform topology optimization based on densimetry, and perform discretization by setting a penalty coefficient to 4 or more in the topology optimization.

An optimization analysis program according to the present invention for joining positions of an automotive body, the program performing optimization analysis to obtain optimal arrangement of joining points to achieve any of improvement of stiffness of an automotive body model, improvement of fatigue life of the joining points of the automotive body model at which parts assembly is joined, and minimization of number of the joining points, for the whole or part of the automotive body model of an automobile including a plurality of part models including a beam element, a two-dimensional element, and/or a three-dimensional element and having initial joining points at which the plurality of part models are joined as the parts assembly, causes a computer to execute as: an analysis object model setting unit that sets the whole or part of the automotive body model as an analysis object model; an optimization analysis model generation unit that generates an optimization analysis model by densely setting all joining candidate points being candidates for the joining points optimally arranged, to the analysis object model; a variable loading condition setting unit that sets a variable loading condition by dividing a variable amplitude load applied to the optimization analysis model into loading conditions of a plurality of different vibration patterns, combines the predetermined numbers of cycles of the respective loading conditions of the respective vibration patterns, and forms one sequence; a target fatigue life setting unit that sets a target fatigue life of the optimization analysis model as number of sequences of the variable loading condition; an optimization analysis condition setting unit that obtains number of cycles to failure of each of the joining candidate points for each of the loading conditions of the vibration patterns, obtains the sum of ratios between the number of cycles and the number of cycles to failure of the loading condition of each vibration pattern as much as the number of sequences of the variable loading condition set in the target fatigue life setting unit, as liner cumulative damage of each of the joining candidate points, and sets a condition about the liner cumulative damage of the joining candidate points to be left after optimization analysis, a condition about stiffness of the optimization analysis model, and a condition about number of joining candidate points to be left after optimization analysis, as objective functions or constraints that are optimization analysis conditions; an optimization analysis unit that applies the variable loading condition set in the variable loading condition setting unit to the optimization analysis model, performs optimization analysis under the optimization analysis conditions, and leaves, as the temporary optimal arrangement of the joining points, arrangement of the joining candidate points to achieve any of reduction of the liner cumulative damage of the joining candidate points, improvement of the stiffness of the optimization analysis model, and minimization of the number of the joining candidate points to be left; a generation unit for analysis object model with joining candidate points selected and set that selects a predetermined number of joining candidate points from among the joining candidate points remaining as the temporary optimal arrangement after the optimization analysis, sets the selected joining candidate points to the analysis object model instead of the initial joining points, and generates an analysis object model with joining candidate points selected and set; a performance calculation unit for selected joining candidate points that performs stress analysis by applying the loading condition of each vibration pattern in the variable loading condition, and the constraint condition, which are set in the variable loading condition setting unit, to the analysis object model with joining candidate points selected and set, and uses a result of the stress analysis to calculate the fatigue life of the selected joining candidate points under the variable loading condition and the stiffness of the analysis object model with joining candidate points selected and set; a determination unit that determines whether the fatigue life of the joining candidate points under the variable loading condition in the analysis object model with joining candidate points selected and set, and the stiffness of the analysis object model with joining candidate points selected and set satisfy predetermined performance exceeding that of the analysis object model to which the initial joining points are set; and an optimal joining point determination unit that determines arrangement of the selected joining candidate points as optimal arrangement of the joining points when it is determined that the predetermined performance is satisfied by the determination unit, and changes the condition about the liner cumulative damage of the joining candidate points to be left after optimization analysis, the condition about the stiffness of the optimization analysis model, or the condition about the number of joining candidate points to be left after the optimization analysis until the predetermined performance is satisfied, when it is determined that the predetermined performance is not satisfied set in the optimization analysis condition setting unit by the determination unit, repeats processing by the optimization analysis unit, the generation unit for analysis object model with joining candidate points selected and set, the performance calculation unit for selected joining candidate points, and the determination unit, and determines the arrangement of the joining candidate points selected when the predetermined performance is satisfied, as the optimal arrangement of the joining points.

### Advantageous Effects of Invention

In the present invention, the whole or part of the automotive body model of the automobile is set as the analysis object model to generate the optimization analysis model in which the joining candidate points to be joined as the parts assembly are set to the analysis object model, and further the optimization analysis for the joining candidate points is performed by setting the optimization analysis condition (objective functions or constraints) about the number of joining candidate points as the object of optimization, the fatigue life of the joining candidate points, the stiffness of the optimization analysis model, and the number of joining points. Therefore, the optimal positions for joining points can be obtained to achieve any of minimization of the number of joining candidate points, improvement of the stiffness of the analysis object model, and improvement of the fatigue life of the joining points at which the parts assembly is joined, when a variable amplitude load changing with time is input to the automotive body, as in the actual traveling of the automobile. This configuration can achieve optimal arrangement of the spot welding positions in the automotive body structure, improvement of fatigue life of spot welding, and improvement of stiffness of the automotive body, whereby reducing welding cost, achieving the high stiffness of the automotive body, reducing the weight of the automotive body.

### BRIEF DESCRIPTION OF DRAWINGS

FIG. 1 is a block diagram of an optimization analysis apparatus for joining positions of an automotive body according to a first embodiment of the present invention.

FIG. 2 is a diagram illustrating an example of a floor structure member model as an analysis object model, and a loading condition of a first vibration pattern (moment around an FR axis) and constraint condition, applied to the floor structure member model, in the first embodiment of the present invention.

FIG. 3 is a diagram illustrating initial joining points set in advance in the floor structure member model as an example of the analysis object model, in the first embodiment of the present invention ((a) perspective view and (b) interval between the initial joining points).

FIG. 4 is a diagram illustrating an example of a loading condition of a second vibration pattern (moment around an RL axis) and constraint condition applied to the floor structure member model as the analysis object model, in the first embodiment of the present invention.

FIG. 5 is a diagram illustrating an example of an optimization analysis model having, as joining candidate points, the initial joining points set in advance in the analysis object model and additional joining points densely added to the analysis object model, in the first embodiment of the present invention ((a) optimization analysis model and (b) joining candidate points set to the optimization analysis model).

FIG. 6 is a graph illustrating an example of a variable loading condition set in the first embodiment of the present invention.

FIG. 7 is a graph illustrating an S—N curve used for calculating fatigue life under the variable loading condition, in the present first embodiment.

FIG. 8 is a diagram illustrating an example of results indicating the fatigue life of the initial joining points under the variable loading condition and the positions of three initial joining points having the shortest fatigue life (minimum fatigue life), in the first embodiment of the present invention.

FIG. 9 is a diagram illustrating an example of a spot welding portion obtained by modeling an initial joining point in the calculation of the fatigue life of the initial joining point in the first embodiment of the present invention ((a) top view and (b) perspective view).

FIG. 10 is a diagram illustrating an example of optimal arrangement of the joining points obtained by optimization analysis under optimization analysis conditions of stiffness and fatigue life, for the floor structure member model as an analysis object, in the first embodiment and a first example of the present invention ((a) perspective view and (b) enlarged view of dotted frame).

FIG. 11 is a flowchart illustrating a process of an optimization analysis method for joining positions of an automotive body, according to the first embodiment of the present invention.

FIG. 12 is a block diagram of an optimization analysis apparatus for joining positions of an automotive body, according to a second embodiment of the present invention.

FIG. 13 is a flowchart illustrating a process of an optimization analysis method for joining positions of an automotive body, according to the second embodiment of the present invention.

FIG. 14 is a diagram illustrating the floor structure member model being a part of an automotive body model as the analysis object, in the first example ((a) overall view and (b) enlarged view of the vicinity of stiffness evaluation point for evaluating stiffness).

FIG. 15 is a diagram illustrating optimal arrangement of the joining points obtained by optimization analysis under optimization analysis condition of stiffness, for the floor structure member model as the analysis object, in the first example.

FIG. 16 is a graph illustrating an improvement rate of stiffness of the floor structure member model in which optimal arrangement of the joining points obtained by the optimization analysis is set, in the first example.

FIG. 17 is a graph illustrating a minimum fatigue life ratio of the joining points in the floor structure member model in which the optimal arrangement of the joining points is set on the basis of the minimum fatigue life of the initial joining points in the floor structure member model in which only the initial joining points are set, in the first example.

FIG. 18 is a diagram illustrating an automotive body model as the analysis object and a variable loading condition given in optimization analysis of the joining points, in a second example ((a) the loading condition of the first vibration pattern and constraint condition, and (b) the loading condition of the second vibration pattern and constraint condition).

FIG. 19 is graphs illustrating results of (a) the minimum fatigue life ratio, (b) the improvement rate of stiffness, and (c) the number of joining points of an automotive body model having set joining points obtained by the optimization analysis for each of conditions 1 to 3 having different combinations of objective functions and constraints of the optimization analysis conditions, in the second example.

### DESCRIPTION OF EMBODIMENTS

Prior to describing an optimization analysis method, apparatus, and program for joining positions of an automotive body according to a first embodiment and a second embodiment of the present invention, an automotive body model being an object in the present invention will be described. Note that in the description and the drawings of the present application, a longitudinal direction of the automotive body, a transverse direction of the automotive body, and a vertical direction of the automotive body are referred to as an X direction, Y direction, and Z direction, respectively. Furthermore, in the present specification and drawings, elements having substantially the same functions and configurations are denoted by the same reference numerals and symbols, and redundant descriptions will be omitted.

### <Automotive Body Model and Analysis Object Model>

The automotive body model being the object in the present invention includes a plurality of part models such as body's frame parts and chassis components, and these part models are formed by modeling using beam elements, two-dimensional elements, and/or three-dimensional elements.

In general, the body's frame parts, the chassis components, and the like are mainly formed from a metal sheet having a thin thickness, and the part models constituting the automotive body model may be formed only of the two-dimensional elements.

Furthermore, the automotive body model has initial joining points at which the plurality of part models as a parts assembly is to be joined. The initial joining points are obtained by modeling spot welding points for joining a plurality of automobile parts as the parts assembly by using the beam elements and the three-dimensional elements.

For example, when two part models constituted by the two-dimensional elements are joined at the initial joining points obtained by modeling using the beam elements, each of the beam elements is connected to both of the two-dimensional elements of the two part models.

In addition, when the initial joining points are obtained by modeling using the three-dimensional elements, the two-dimensional elements of the part model and the three-dimensional elements at the initial joining points are connected with a rigid body element in order to distribute a translational force acting on the initial joining points to the part models.

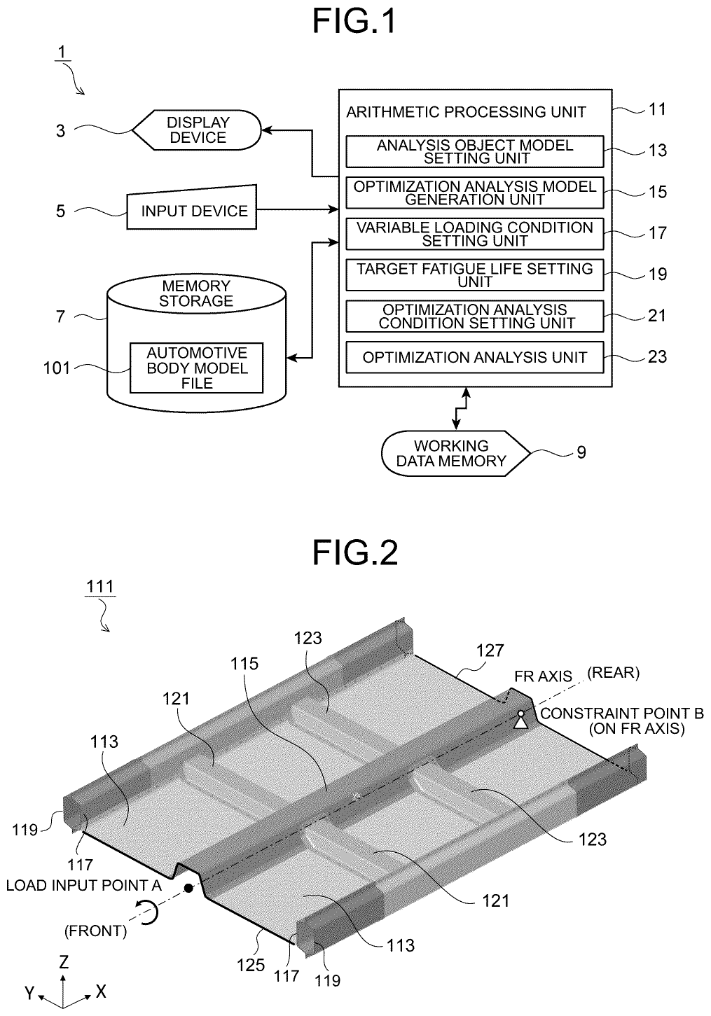

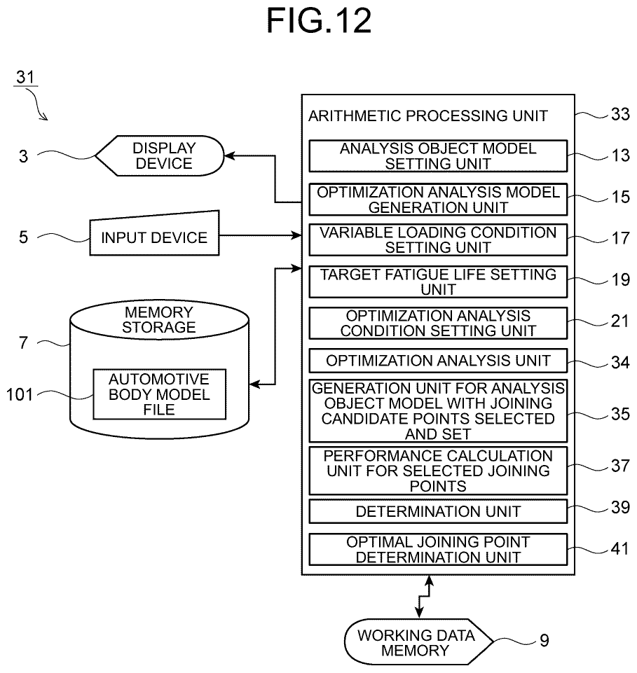

The present invention is configured to analyze deformation caused by the change in variable amplitude load acting on an analysis object model (described later) that is the whole or part of the automotive body model, and therefore, each of the part models in the automotive body model is modeled as an elastic body, a viscoelastic body, or an elastoplastic body. Then, a material property and element information of each part model constituting the automotive body model, and further information about the initial joining points and the like in each parts assembly are stored in an automotive body model file 101 (see FIGS. 1 and 12).

### First Embodiment

### <Optimization Analysis Apparatus for Joining Positions of Automotive Body>

A configuration of the optimization analysis apparatus for joining positions of an automotive body (hereinafter, simply referred to as “optimization analysis apparatus”) according to the first embodiment of the present invention will be described below.

The optimization analysis apparatus is an apparatus that performs optimization analysis to obtain optimal arrangement of joining points to achieve any of improvement of stiffness of an automotive body model, improvement of fatigue life of a joining point of an automotive body model at which a parts assembly is joined, and minimization of the number of the joining points, for an analysis object model being the whole or part of the automotive body model.

FIG. 1 illustrates an example of the configuration of an optimization analysis apparatus 1 according to the present first embodiment. The optimization analysis apparatus 1 is constituted by a personal computer (PC) or the like, and includes a display device 3, an input device 5, a memory storage 7, a working data memory 9, and an arithmetic processing unit 11 as illustrated in FIG. 1. The display device 3, the input device 5, the memory storage 7, and the working data memory 9 are connected to the arithmetic processing unit 11, and each function thereof is executed by a command from the arithmetic processing unit 11. The functions of the respective component elements of the optimization analysis apparatus 1 according to the present first embodiment will be described below.

### <<Display Device>>

The display device 3 is used to display the automotive body model, the analysis object model, an analysis result, and the like, and includes an LCD monitor or the like.

### <<Input Device>>

The input device 5 is used to input an operator's instruction such as to read the automotive body model file 101 (FIG. 1) or display the automotive body model and the analysis object model, and includes a keyboard, a mouse, or the like.

### <<Memory Storage>>

The memory storage 7 is used to store various files such as the automotive body model file 101 (FIG. 1) and the analysis results, and includes a hard disk or the like.

### <<Working Data Memory>>

The working data memory 9 is used to temporarily store or calculate data used by the arithmetic processing unit 11, and includes a random access memory (RAM) or the like.

### <<Arithmetic Processing Unit>>

As illustrated in FIG. 1, the arithmetic processing unit 11 includes an analysis object model setting unit 13, an optimization analysis model generation unit 15, a variable loading condition setting unit 17, a target fatigue life setting unit 19, an optimization analysis condition setting unit 21, and an optimization analysis unit 23, and is constituted by a central processing unit (CPU) such as PC. Each of these units functions when the CPU executes a predetermined program. The functions of the units of the arithmetic processing unit 11 will be described below.

### (Analysis Object Model Setting Unit)

The analysis object model setting unit 13 acquires the automotive body model from the automotive body model file 101, and sets the whole or part of the acquired automotive body model as the analysis object model.

An example of processing by the analysis object model setting unit 13 will be described below. First, the operator gives an instruction for reading the automotive body model from the automotive body model file 101 by using the input device 5, and the automotive body model is read from the memory storage 7. Next, the automotive body model is displayed on the display device 3 according to the operator's instruction. Then, a portion being an object of optimization analysis in the automotive body model displayed on the display device 3 is specified by the operator's instruction. The analysis object model setting unit 13 sets the specified portion as the analysis object model.

FIG. 2 illustrates an example of setting of a floor structure member model 111 that is obtained by modeling a simplified floor portion being a part of the automotive body, as the analysis object model.

The floor structure member model 111 includes, as part models, a floor panel model 113, a floor tunnel member model 115, a locker inner model 117, a locker outer model 119, a front floor cross member model 121, and a rear floor cross member model 123. The locker inner model 117 and the locker outer model 119 are each formed by connecting three members continuous in the longitudinal direction of the automotive body.

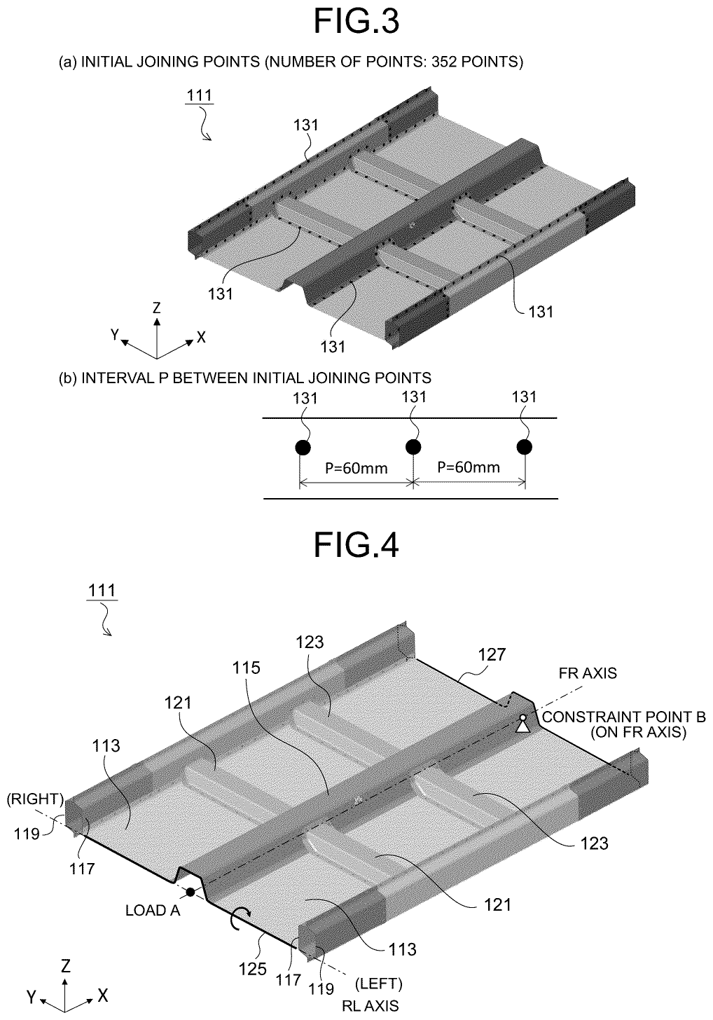

As illustrated in FIG. 3, in these part models, initial joining points 131 at which the part models are to be joined as the parts assembly are set in advance at a predetermined interval P. The initial joining points 131 are modeled using, for example, beam elements that connect nodes of two-dimensional elements or the like of a plurality of part models constituting the parts assembly.

Furthermore, as illustrated in FIGS. 2 and 4, in order to set a variable loading condition and a constraint condition that are to be applied to the floor structure member model 111 by the variable loading condition setting unit 17 which is described later, front end surfaces and rear end surfaces of the floor panel model 113 and the floor tunnel member model 115 of the floor structure member model 111 are connected with the rigid body elements to generate a front end surface portion 125 and a rear end surface portion 127. Here, the center of gravity of the front end surface portion 125 is defined as a load input point A, the front end surface portion 125 is connected with the rigid body element, and the center of gravity of the rear end surface portion 127 is defined as a constraint point B. An axis passing through the load input point A in the longitudinal direction of the automotive body (X direction in FIG. 2) is defined as an FR axis, and an axis passing through the load input point A in the transverse direction of the automotive body (Y direction in FIG. 4) is defined as an RL axis.

### (Optimization Analysis Model Generation Unit)

The optimization analysis model generation unit 15 generates an optimization analysis model by densely setting all joining candidate points that are candidates for optimally arranged joining points for joining the parts assembly to the analysis object model.

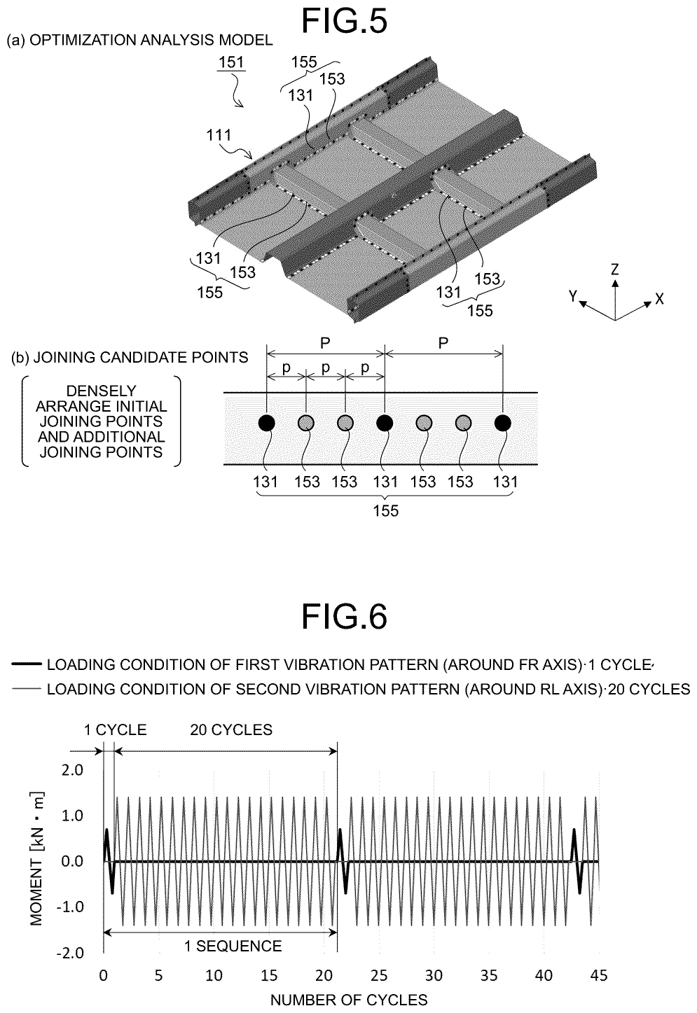

FIG. 5 illustrates, as an example, an optimization analysis model 151 generated by setting joining candidate points 155 to the floor structure member model 111.

In the floor structure member model 111, as illustrated in FIG. 3 described above, the initial joining points 131 are set in advance at the predetermined interval P, to the parts assembly obtained by joining a plurality of parts.

As illustrated in FIG. 5, the optimization analysis model generation unit 15 densely sets additional joining points 153 between the initial joining points 131 at a predetermined interval p (<P), in each parts assembly. Then, both the initial joining points 131 set in advance in the floor structure member model 111 and the additional joining points 153 are set as the joining candidate points 155, generating the optimization analysis model 151.

Note that, in a procedure for setting the joining candidate points by the optimization analysis model generation unit 15, the additional joining points are preferably set according to the size of a portion joined as the parts assembly in the analysis object model, such as setting adjacent joining points closest at an interval at which the additional joining points can be actually increased, for example, at which no current shunt occurs upon joining between the adjacent joining points.

Furthermore, the additional joining points may be obtained by modeling using the beam element or by modeling using a three-dimensional element, similarly to the initial joining points described above.

In the present first embodiment, the optimization analysis model 151 will be described below that is generated by setting the additional joining points 153 to the floor structure member model 111 as illustrated in FIG. 5.

### (Variable Loading Condition Setting Unit)

The variable loading condition setting unit 17 sets the variable loading condition by dividing a variable amplitude load applied to the optimization analysis model into loading conditions of a plurality of different vibration patterns, combining predetermined numbers of cycles of the respective loading conditions of the respective vibration patterns, and forming one sequence.

The variable amplitude load is obtained by combining predetermined numbers of cycles of vibration patterns different in at least one of a magnitude, position, and direction that are obtained by dividing a load input to the analysis object model, and the variable amplitude load simulates a variable amplitude load input to an automotive body of an actual traveling automobile and changing with time. The variable loading condition is given in calculation of the fatigue life of the initial joining points or joining candidate points which are described later.

Note that the variable loading condition setting unit 17 may set the variable loading condition that is obtained by combining divided loads obtained by dividing the variable amplitude load to have a plurality of different variation patterns, and the constraint condition for each variable loading condition to constrain the analysis object model.

In the present first embodiment, the variable loading condition includes a loading condition of a first vibration pattern in which a load (moment) such as twisting around the FR axis is input to the load input point A of the floor structure member model 111, as illustrated in FIG. 2, and a loading condition of a second vibration pattern in which a load (moment) such as twisting around the RL axis is input to the load input point A, as illustrated in FIG. 4.

As illustrated in FIG. 6, the variable loading condition is defined as one sequence of variable loading condition that has a combination of one cycle of the loading condition of the first vibration pattern and 20 cycles of the loading condition of the second vibration pattern. Here, in the graph illustrated in FIG. 6, in order to indicate the number of cycles of each of the loading condition of the first vibration pattern and the loading condition of the second vibration pattern in one sequence of variable loading condition, an alternate variable amplitude load is schematically illustrated in which the magnitude of a load in each of the loading condition of the first vibration pattern and the loading condition of the second vibration pattern is represented as amplitude.

Note that in the example of the variable loading condition illustrated in FIG. 6, the amplitude of the load corresponding to the loading condition of the first vibration pattern is 0.7 kN·m and the amplitude of the load corresponding to the loading condition of the second vibration pattern is 1.4 kN.

In addition, in the present first embodiment, the constraint condition defines a constraint point B of the floor structure member model 111 as a complete restraint point, as illustrated in FIGS. 2 and 4.

### (Target Fatigue Life Setting Unit)

The target fatigue life setting unit 19 sets the target fatigue life of the optimization analysis model as the number of sequences of the variable loading condition.

For the target fatigue life of the optimization analysis model, the loading conditions of the vibration patterns in the variable loading condition set by the variable loading condition setting unit 17 may be applied to the analysis object model to separately perform stress analysis, calculating the number of sequences reaching fracture (fatigue failure) under the variable loading condition at the initial joining points of the analysis object model, as the fatigue life by using a result of the stress analysis, setting the target fatigue life on the basis of the calculated fatigue life of the initial joining points. Alternatively, a predetermined number of sequences may be used as the target fatigue life of the optimization analysis model from a conventional empirical rule.

In general, the load input to the automotive body of the actual automobile is not constant in terms of time, and therefore, it is regarded that a stress state has stresses having various amplitudes, generated at random at the initial joining points. In order to evaluate the fatigue life of the initial joining points in such a stress state, a linear cumulative damage rule is used.

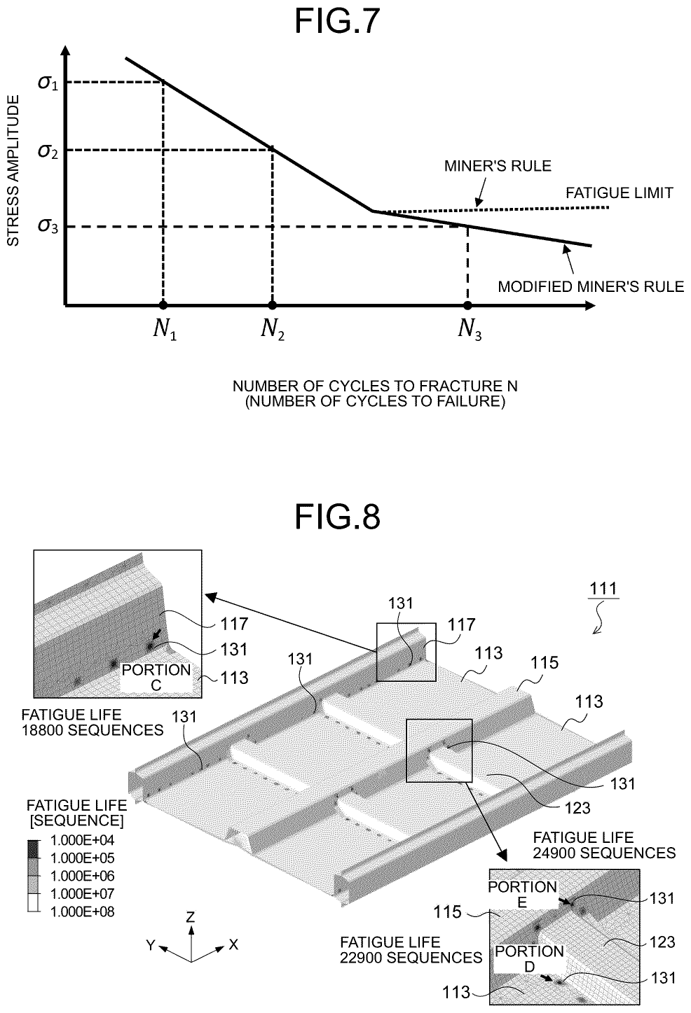

In the linear cumulative damage rule, first, a state in which stresses having various amplitudes are generated at random is considered to be a state in which stresses having different amplitudes such as σ1, σ2, σ3, . . . , σm are individually repeated. Next, assuming that the stress amplitudes σ1, σ2, σ3, . . . , and σm are individually generated, the numbers of cycles (the numbers of cycles to failure) N1, N2, N3, . . . , and Nm until fracture (fatigue failure) at each stress amplitude is read from an S—N curve as illustrated in FIG. 7. A damage degree when each of these stress amplitudes is repeated by n1, n2, n3, . . . , and nm is considered as n1/N1, n2/N2, n3/N3, . . . , and nm/Nm.

In the linear cumulative damage rule, as shown in Formula (1), a liner cumulative damage dm that is the sum of the damage degrees at individual stress amplitudes, is obtained. When the liner cumulative damage dm≥1, the fatigue failure occurs. Note that in the variable loading condition of irregular cyclic variable amplitude load, a rainflow counting method may be used to determine the stress amplitudes σ1, σ2, σ3, . . . , and σm and the numbers of cycles n1, n2, n3, . . . , and nm.

$$d m = {\sum }_{i = 1}^{m} \frac{{n}_{i}}{{N}_{i}} = \frac{{n}_{1}}{{N}_{1}} + \frac{{n}_{2}}{{N}_{2}} + \frac{{n}_{3}}{{N}_{3}} + … + \frac{{n}_{m}}{{N}_{m}} \qquad ( 1 )$$

A specific procedure for calculating a target liner cumulative damage of the initial joining points under the variable loading condition by the target fatigue life setting unit 19 is as follows.

First, the stress acting on the initial joining points obtained by the stress analysis for the loading conditions of the vibration patterns under the variable loading condition is defined as different stress amplitudes σ1, σ2, σ3, . . . , and σm generated at the initial joining points under the variable loading condition.

Next, the target fatigue life setting unit 19 obtains the numbers of cycles (the numbers of cycles to failure) N1, N2, N3, . . . , and Nm until the fracture of the initial joining points 131 during generation of the individual stress amplitudes at the initial joining points 131, from the S—N curve (FIG. 7).

Subsequently, the numbers of cycles (the numbers of cycles to failure) N1, N2, N3, . . . , and Nm until fracture at the respective stress amplitudes and the numbers of cycles n1, n2, n3, . . . , and nm of the loading conditions of the respective vibration patterns of one sequence of the variable loading condition are substituted in Formula (1) to calculate the liner cumulative damage dm per one sequence. Furthermore, a liner cumulative damage DM when one sequence of the variable loading condition is continuously repeated K times (K sequences) is calculated according to Formula (2).

$$D M = {\sum }_{j = 1}^{k} {\sum }_{í = 1}^{m} \frac{{n}_{i}}{{N}_{ì}} = {\sum }_{j = 1}^{K} ( \frac{{n}_{1}}{{N}_{1}} + \frac{{n}_{2}}{{N}_{2}} + \frac{{n}_{3}}{{N}_{3}} + … + \frac{{n}_{m}}{{N}_{m}} ) \qquad ( 2 )$$

Then, the number of sequences K when the liner cumulative damage DM is 1 or more is calculated as the fatigue life of the initial joining points under the variable loading condition.

The target fatigue life setting unit 19 sets the target fatigue life on the basis of the fatigue life of the respective initial joining points 131 calculated in this manner. The target fatigue life is a fatigue life to be satisfied by the joining candidate points (described later) remaining after the optimization analysis. In the present first embodiment, the target fatigue life is at least a long fatigue life equal to or longer than the shortest fatigue life (minimum fatigue life) of that of each initial joining point calculated by the target fatigue life setting unit 19.

FIG. 8 illustrates an example of results indicating the positions of the three initial joining points and the fatigue life thereof, and the three initial joining points have the shortest fatigue life from among the fatigue life of the initial joining points 131 obtained using results of the stress analysis in which the variable loading condition illustrated in FIG. 6 and constraint condition are applied to the floor structure member model 111.

The fatigue life of the initial joining points 131 illustrated in FIG. 8 is calculated under the variable loading condition in which a combination of one cycle of an alternate moment of 0.7 kN·m around the FR axis as the loading condition of the first vibration pattern (FIG. 2) and 20 cycles of an alternate moment of 1.4 kN·m around the RL axis as the loading condition of the second vibration pattern (FIG. 4) is defined as one sequence. A specific procedure for calculating the target fatigue life of the initial joining points 131 will be described in a first example described later.

As illustrated in FIG. 8, in the fatigue life obtained for each initial joining point 131 of the floor structure member model 111, the fatigue life of an initial joining point 131 at a portion C where the floor panel model 113 and the locker inner model 117 are joined was the shortest 18800 sequences, next, the fatigue life of an initial joining point 131 at a portion D where the floor panel model 113 and the rear floor cross member model 123 are joined was 22900 sequences, and the fatigue life of an initial joining point 131 at a portion E where the floor tunnel member model 115 and the rear floor cross member model 123 are joined was 24900 sequences. From this result, the target fatigue life setting unit 19 sets the long fatigue life equal to or longer than the fatigue life of the initial joining point 131 in the portion C, as the target fatigue life.

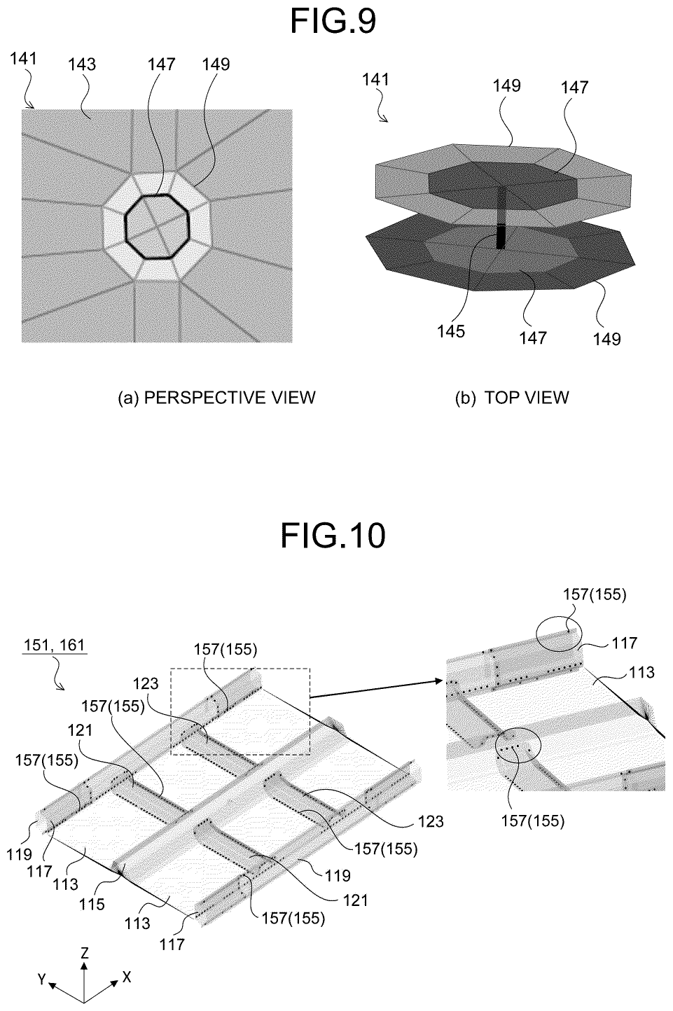

Note that for calculation of the fatigue life of each of initial joining points by the target fatigue life setting unit 19, it is preferable to set a portion (center portion 147 and peripheral portion 149) of a part model 143 to which a beam element 145 is connected, on the basis of a nugget diameter of an actual spot welding point, cut the portion into web-shaped two-dimensional elements again, and use stress values of the two-dimensional elements in the peripheral portion 149, as in a spot welding portion 141 illustrated in FIG. 9

Furthermore, for calculation of the fatigue life by the target fatigue life setting unit 19, a commercially available fatigue life prediction analysis software is preferably used. For example, for calculation of the fatigue life of the initial joining points obtained by modeling using the beam elements by using the commercially available fatigue life prediction analysis software, conditions such as stress on the initial joining points and the like can be input to the fatigue life prediction analysis software to calculate the fatigue life of the initial joining points. For the stress on the initial joining points, the stress values of the two-dimensional elements of each part model to which the beam elements are connected, or nominal structure stress obtained from a force and moment acting on both ends of the beam element can be used.

In addition, although the S—N curve may change depending on a loading state of the load, for example, whether the average stress is compressive stress or tensile stress even with the same stress amplitude, the values of the fatigue life prediction analysis software or experimental values are preferably referred to. Alternatively, in calculation of the fatigue life using the nominal structure stress, one S—N curve including different loading states may be used. Furthermore, as illustrated in FIG. 7, the S—N curve may be represented by applying various laws such as Miner's rule in which no fracture is determined upon application of low stress below a fatigue limit and modified Miner's rule in which the fracture is counted as damage even upon application of the low stress below the fatigue limit.

### (Optimization Analysis Condition Setting Unit)

In order to perform optimization analysis for the optimization analysis model as an object of optimization, the optimization analysis condition setting unit 21 obtains the number of cycles to failure of each joining candidate point for each of the loading conditions of the vibration patterns set by the variable loading condition setting unit 17, obtains, as the liner cumulative damage DM of each joining candidate point, the sum of ratios between the number of cycles and the number of cycles to failure of the loading condition of each vibration pattern as much as the number of sequences of the variable loading condition set by the target fatigue life setting unit 19, and sets, as objective functions or constraints that is an optimization analysis condition, a condition about the liner cumulative damage of joining candidate points to be left after the optimization analysis, a condition about the stiffness of the optimization analysis model, and a condition about the number of joining candidate points to be left after the optimization analysis.

The optimization analysis conditions include two types of objective function and constraint. Only one objective function is set according to a purpose of the optimization analysis. In the present first embodiment, the condition about the stiffness of the optimization analysis model is set as the objective function.

As the condition about the stiffness, for example, a predetermined position in the analysis object model is preferably used as a stiffness evaluation point so that displacement or strain of the stiffness evaluation point is used as an index. Then, in the variable loading condition, for example, minimization of a value obtained by adding the amounts of displacement of the stiffness evaluation points P under the loading condition of each vibration pattern or minimization of the displacement of the stiffness evaluation point P under the loading condition of each vibration pattern is preferably set as the condition about the stiffness.

The constraint is a constraint imposed to perform the optimization analysis, and a plurality of the constraints is set as necessary.

In the present first embodiment, a condition that the fatigue life of the joining candidate points is larger than the target fatigue life set by the target fatigue life setting unit 19 is preferably set as a constraint. Similarly to the number of cycles to failure of the initial joining points under the variable loading condition described above, the number of cycles to failure of the joining candidate points can be calculated using the S—N curve illustrated in FIG. 7.

The condition about the fatigue life is not limited to the condition in which the target fatigue life set by the target fatigue life setting unit 19 is directly given as the constraint, but may be given as the constraint in which the liner cumulative damage DM of the joining candidate points under the variable loading condition, corresponding to the number of sequences set as the target fatigue life by the target fatigue life setting unit 19, is the liner cumulative damage DM<1 where no fatigue failure occurs.

Here, the liner cumulative damage DM of the joining candidate points can be calculated using the S—N curve and Formula (2) illustrated in FIG. 7, for example, on the basis of the stress on the two-dimensional elements of the part model to which the beam elements modeled as the joining candidate points are connected, the nominal structure stress calculated from the force and moment acting on both ends of each beam element, and the like, similarly to the liner cumulative damage DM of the initial joining points, described above.

Furthermore, in the condition about the number of joining candidate points, the number of joining candidate points to be left can be set to a predetermined value. In the present first embodiment, the constraint has been set that the number of joining candidate points to be left is the same as the number of initial joining points.

Note that, for the optimization analysis condition about the number of joining candidate points, for example, in a case where densimetry is applied using topology optimization in the optimization analysis by the optimization analysis unit 23, which is described later, a volume of the joining candidate points calculated on the basis of a density of the elements (beam element, three-dimensional element, etc.) to be modeled as the joining candidate points may be given as the constraint.

### (Optimization Analysis Unit)

The optimization analysis unit 23 applies the variable loading condition set by the variable loading condition setting unit 17 to the optimization analysis model, performs the optimization analysis under the optimization analysis condition, and obtains, as the optimal arrangement of the joining points, the arrangement of the joining candidate points to achieve any of reduction of the liner cumulative damage of the joining candidate points, improvement of the stiffness of the optimization analysis model, and minimization of the number of the joining candidate points to be left.

For the optimization analysis by the optimization analysis unit 23, the topology optimization can be applied. In a case where the densimetry is used in the topology optimization, a normalized virtual density taking values from 0 to 1 is given as a design variable to the elements (beam element, three-dimensional element, etc.) modeled as the joining candidate points, and a value of the density satisfying the optimization analysis condition is calculated.

Then, a calculated value of the density of 1 indicates a state in which the joining candidate points are completely located, a calculated value of 0 indicates a state in which no joining candidate point is located, and a calculated value having an intermediate value indicates that joining of the parts assembly by the joining candidate points is in an intermediate state.

Therefore, when the density often has the intermediate value upon application of the densimetry in the topology optimization, it is preferable to perform discretization by using a penalty coefficient as shown in Formula (3). Note that K_{M} is a stiffness matrix obtained by penalizing a stiffness matrix of an element, K is the stiffness matrix of the element, ρ is a normalized density, and p is the penalty coefficient.

$${K}_{\text{?}} ( ρ ) = {ρ}^{p} K \qquad ( 3 )$$

$$\text{?} \text{indicates text missing or illegible when filed}$$

Where
K_{M}: Stiffness matrix obtained by penalizing stiffness matrix of element
K: Stiffness matrices of element
ρ: Normalized density
p: Penalty coefficient

Although penalty coefficient often used for discretization is two or more, penalty coefficient used for the optimization analysis for joining positions according to the present invention is preferably four or more. Furthermore, it is more preferable to use, as penalty coefficient, four or more for the two-dimensional element and the three-dimensional element and 20 or more for the beam element.

Note that the optimization analysis unit 23 may perform optimization analysis by using the topology optimization as described above, or may perform optimization analysis by using another calculation method.

FIG. 10 illustrates an example of the optimal arrangement of joining points 157 obtained by performing the optimization analysis in which the densimetry is applied, in the topology optimization by the optimization analysis unit 23. Note that the functions and effects of the optimal arrangement of the joining points obtained in the present first embodiment will be described in the first example described later.

### <Optimization Analysis Method for Joining Positions of Automotive Body>

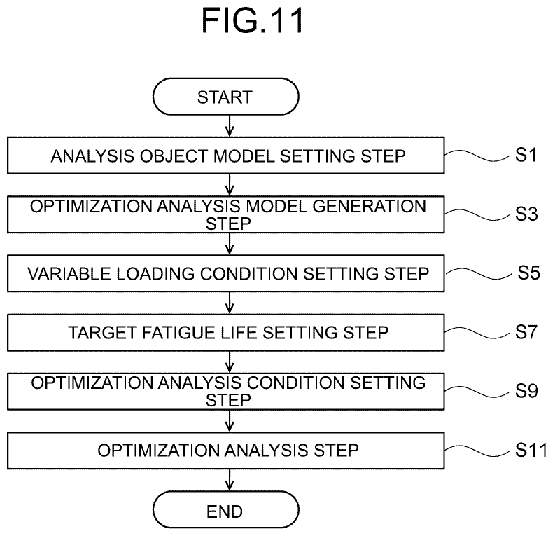

In the optimization analysis method for joining positions of an automotive body (hereinafter, simply referred to as “optimization analysis method”) according to the first embodiment of the present invention, a computer performs the following steps for the whole or part of the automotive body model of the automobile that includes a plurality of part models including the beam element, the two-dimensional element, and/or the three-dimensional element and that has the initial joining points at which the plurality of part models as the parts assembly is joined, for optimization analysis to obtain optimal arrangement of the joining points to achieve any of improvement of stiffness of the automotive body model, improvement of fatigue life of the joining points of the automotive body model at which the parts assembly is joined, and minimization of the number of the joining points, and the method includes an analysis object model setting step S1, an optimization analysis model generation step S3, a variable loading condition setting step S5, a target fatigue life setting step S7, an optimization analysis condition setting step S9, and an optimization analysis step S11, as illustrated in FIG. 11. Each of these steps will be described below. Note that the following steps are performed by the optimization analysis apparatus 1 (FIG. 1) constituted by the computer.

### <<Analysis Object Model Setting Step>>

In the analysis object model setting step S1, the whole or part of the automotive body model is set as the analysis object model.

In the present first embodiment, in the analysis object model setting step S1, the analysis object model setting unit 13 sets the floor structure member model 111 as a part of the automotive body model, as the analysis object model.

### <<Optimization Analysis Model Generation Step>>

In the optimization analysis model generation step S3, the optimization analysis model is generated by densely setting all joining candidate points that are candidates for the optimally arranged joining points to the analysis object model.

In the present first embodiment, in the optimization analysis model generation step S3, the optimization analysis model generation unit 15 densely generates the additional joining points 153, between the initial joining points 131 set to the floor structure member model 111 in advance, at a predetermined interval p (p<P, P: interval between initial joining points) at which the additional joining points 153 can be actually increased, for example, at which no current shunt occurs upon joining between the adjacent joining points, and both the initial joining points 131 and the additional joining points 153 are set as the joining candidate points 155.

### <<Variable Loading Condition Setting Step>>

In the variable loading condition setting step S5, the variable loading condition is set by dividing the variable amplitude load applied to the optimization analysis model into the loading conditions of the plurality of different vibration patterns, combining the predetermined numbers of cycles of the respective loading conditions of the respective vibration patterns, and forming one sequence.

In the present first embodiment, in the variable loading condition setting step S5, the variable loading condition setting unit 17 of the optimization analysis apparatus 1 sets the variable loading condition in which one cycle of the loading condition of the first vibration pattern illustrated in FIG. 2 and 20 cycles of the loading condition of the second vibration pattern illustrated in FIG. 4 are combined into one sequence (see FIG. 6), and further sets the constraint condition to constrain the constraint point B as illustrated in FIGS. 2 and 4.

### <<Target Fatigue Life Setting Step>>

In the target fatigue life setting step S7, the target fatigue life of the optimization analysis model is set as the number of sequences of the variable loading condition set in the variable loading condition setting step S5. For the target fatigue life of the optimization analysis model, the loading conditions of the vibration patterns under the variable loading condition set in the variable loading condition setting step S5 may be applied to the analysis object model to separately perform the stress analysis, calculating the number of sequences of the variable loading condition to be the fatigue life under the variable loading condition of the initial joining points of the analysis object model by using a result of the stress analysis, setting the number of sequences of the variable loading condition to be the target fatigue life on the basis of the calculated number of sequences of the variable loading condition to be the fatigue life of the initial joining points. Alternately, a predetermined number of sequences of the variable loading condition may be set as the target fatigue life from a conventional empirical rule.

Here, the target fatigue life is a fatigue life to be satisfied by a joining candidate point as the object of optimization, and at least a larger number of sequences of the variable loading condition equal to or larger than the number of sequences of the variable loading condition that is the shortest fatigue life (minimum fatigue life) of each initial joining point calculated in the target fatigue life setting step S7 is set as the target fatigue life.

### <<Optimization Analysis Condition Setting Step>>

In the optimization analysis condition setting step S9, in order to perform optimization analysis for the optimization analysis model as the object of optimization, the number of cycles to failure of each joining candidate point is obtained for each of the plurality of different loading conditions of the vibration patterns obtained by dividing the variable amplitude load in the variable loading condition setting step S5, the sum of ratios between the number of cycles and the number of cycles to failure of the loading condition of each vibration pattern, as much as the number of sequences of the variable loading condition set in the target fatigue life setting step S7, is obtained as the liner cumulative damage DM of each joining candidate point, and the condition about the liner cumulative damage of joining candidate points to be left after the optimization analysis, the condition about the stiffness of the optimization analysis model, and the condition about the number of joining candidate points to be left after the optimization analysis are set as the objective functions or constraints that is the optimization analysis condition.

In the present first embodiment, in the optimization analysis condition setting step S9, the optimization analysis condition setting unit 21 sets, as the optimization analysis conditions, maximization of the stiffness of the optimization analysis model (minimization of the displacement of the stiffness evaluation point P) as the objective function, the constraint that the fatigue life of the joining candidate points 155 is larger than the target fatigue life, and the constraint that the number of joining candidate points to be left is the same as the number of initial joining points.

As the condition about the stiffness, for example, the predetermined position in the analysis object model is preferably used as the stiffness evaluation point so that displacement or strain of the stiffness evaluation point is used as the index. Then, in the variable loading condition, for example, minimization of a value obtained by adding the amounts of displacement of the stiffness evaluation points P under the loading condition of each vibration pattern obtained by dividing the variable amplitude load, or minimization of the displacement of the stiffness evaluation point P under the variable loading condition may be a condition about stiffness.

In addition, the condition about the fatigue life is not limited to the condition in which the target fatigue life set in the target fatigue life setting step S7 is directly given as the constraint, but may be given as, for example, a constraint in which the liner cumulative damage DM of the joining candidate points is equal to or less than the liner cumulative damage corresponding to the target fatigue life.

### <<Optimization Analysis Step>>

In the optimization analysis step S11, the variable loading condition set in the variable loading condition setting step S5 is applied to the optimization analysis model, the optimization analysis under the optimization analysis conditions is performed, and the arrangement of the joining candidate points to achieve any of reduction of the liner cumulative damage of the joining candidate points, improvement of the stiffness of the optimization analysis model, and minimization of the number of the joining candidate points to be left is obtained as the optimal arrangement of the joining points.

In the present first embodiment, in the optimization analysis step S11, the optimization analysis unit 23 performs the optimization analysis by using the joining candidate points set to the floor structure member model 111 as the object of optimizations, and obtains the arrangement of the joining candidate points 155 satisfying the optimization analysis conditions as the optimal arrangement of the joining points 157 as illustrated in FIG. 10.

### <Optimization Analysis Program for Joining Positions of Automotive Body>

The first embodiment of the present invention can be configured as the optimization analysis program for joining positions of an automotive body that causes the respective units of the optimization analysis apparatus 1 for joining positions of an automotive body, constituted by the computer to perform functions. In other words, the optimization analysis program for joining positions of an automotive body according to the first embodiment of the present invention performs the optimization analysis of obtaining the optimal arrangement of the joining points to achieve any of improvement of the stiffness of the automotive body model, improvement of the fatigue life of the joining points at which the parts assembly in the automotive body model is joined, and minimization of the number of the joining points, for the analysis object model being the whole or part of the automotive body model, and the program causes the computer to function as the analysis object model setting unit 13, the optimization analysis model generation unit 15, the variable loading condition setting unit 17, the target fatigue life setting unit 19, the optimization analysis condition setting unit 21, and the optimization analysis unit 23, as illustrated in FIG. 1 as an example.

As described above, according to the optimization analysis method, apparatus, and program for joining positions of an automotive body according to the present first embodiment, the whole or part of the automotive body model of the automobile is set as the analysis object model, the optimization analysis model is generated to which the joining candidate points to be joined as the parts assembly to the analysis object model are set, the optimization analysis conditions (objective functions or constraints) about the number of the joining candidate points to be left as the object of optimization, the fatigue life, and the stiffness of the optimization analysis model are set, and the optimization analysis for the joining candidate points is performed. Therefore, the optimal arrangement of the joining points can be obtained to achieve any of minimization of the number of the joining candidate points, improvement of the stiffness of the optimization analysis model, and improvement of the fatigue life of the joining points at which the parts assembly is joined, when the variable amplitude load whose amplitude, direction, or the like changes with time is input to the automotive body.

### Second Embodiment

In the first embodiment of the present invention described above, the topology optimization based on the densimetry has been applied to the optimization analysis to obtain the joining candidate points satisfying the optimization analysis conditions. It is determined, on the basis of the value of the density of the joining candidate points, whether the joining candidate points remain or disappear in the topology optimization.

As described above, the density in the topology optimization based on the densimetry is a normalized virtual density having values from 0 to 1, a value of the density of 1 indicates a state in which the joining candidate points remains completely, and a value of the density of 0 indicates a state in which the joining candidate points disappears, and a value having an intermediate value between 0 and 1 indicates that the remaining and disappearance of the joining candidate points are in an intermediate state.

Therefore, when the density often has the intermediate value upon application of the densimetry in the topology optimization, it is preferable to perform discretization by using the penalty coefficient as shown in Formula (1).

Then, when discretization is performed by giving the penalty coefficient in the topology optimization, both the fatigue life of the joining points and stiffness in the analysis object model, to which the arrangement of a predetermined number of joining candidate points remaining after the optimization analysis is set as the optimal arrangement of the joining points, satisfy a target performance of the fatigue life and stiffness.

However, when no discretization is performed by giving the penalty coefficient in the topology optimization, the joining candidate points having an intermediate density remain in the optimization analysis model after the optimization analysis. Then, in order to obtain the optimal arrangement of the predetermined number of joining points on the basis of a result of the optimization analysis, for example, the arrangement of the joining candidate points having a density equal to or larger than a certain threshold is selected as the optimal arrangement of the joining points, and the arrangement of the joining candidate points having a density of an intermediate value less than the threshold is not selected as the optimal arrangement of the joining points.

Setting the new optimal arrangement of the joining points thus obtained to the analysis object model and calculating the fatigue life of the analysis object model may cause a problem, that stress concentrating on a specific joining point gives the fatigue life smaller than the target fatigue life or that the stiffness of the analysis object model decreases, not to satisfy predetermined performance in fatigue life and/or stiffness.

Therefore, as a result of intensive studies to solve the above problems, it was found that when making a determination of whether the fatigue life and stiffness of the analysis object model, to which arrangement of the selected joining candidate points instead of the initial joining points is set, satisfy the predetermined performance shows a result that the fatigue life and stiffness do not satisfy the predetermined performance, changing the optimization analysis condition (e.g., threshold for density) and performing the optimization analysis again makes it possible to obtain the optimal arrangement of the joining points satisfying the predetermined performance in stiffness and fatigue life.

The optimization analysis method, apparatus, and program for joining positions of an automotive body according to the present second embodiment have been made from the above knowledge, and a specific configuration thereof will be described. Note that redundant descriptions of the same component elements as those in the optimization analysis method, apparatus, and program for joining positions of an automotive body according to the present second embodiment will be omitted.

### <Optimization Analysis Apparatus for Joining Positions of Automotive Body>

A configuration of an optimization analysis apparatus for joining positions of an automotive body according to the second embodiment of the present invention will be described below.

An optimization analysis apparatus 31 is an apparatus that performs optimization analysis to obtain optimal arrangement of joining points to achieve any of improvement of the stiffness of an automotive body model, improvement of the fatigue life of the joining points of the automotive body model at which the parts assembly is joined, and minimization of the number of the joining points, for the whole or part of the automotive body model, as the analysis object model, including a plurality of part models including the beam element, the two-dimensional element, and/or the three-dimensional element and having the initial joining points at which the plurality of part models as the parts assembly are joined, and the apparatus is constituted by PC or the like and includes the display device 3, the input device 5, the memory storage 7, the working data memory 9, and an arithmetic processing unit 33, as illustrated in FIG. 12. Then, the display device 3, the input device 5, the memory storage 7, and the working data memory 9 are connected to the arithmetic processing unit 33, and each function thereof is executed by a command from the arithmetic processing unit 33.

### <<Arithmetic Processing Unit>>

As illustrated in FIG. 12, the arithmetic processing unit 33 includes the analysis object model setting unit 13, the optimization analysis model generation unit 15, the variable loading condition setting unit 17, the target fatigue life setting unit 19, the optimization analysis condition setting unit 21, and an optimization analysis unit 34, further includes a generation unit 35 for analysis object model with joining candidate points selected and set, a performance calculation unit 37 for selected joining candidate points, a determination unit 39, and an optimal joining point determination unit 41, and is constituted by the central processing unit (CPU) such as PC. Each of these units functions when the CPU executes a predetermined program.

In the arithmetic processing unit 33, the analysis object model setting unit 13, the optimization analysis model generation unit 15, the variable loading condition setting unit 17, the target fatigue life setting unit 19, and the optimization analysis condition setting unit 21 have similar functions to those in the present first embodiment described above, and therefore, the functions of the optimization analysis unit 34, the generation unit 35 for analysis object model with joining candidate points selected and set, the performance calculation unit 37 for selected joining candidate points, the determination unit 39, and the optimal joining point determination unit 41 will be described below.

### (Optimization Analysis Unit)

The optimization analysis unit 34 applies the variable loading condition set by the variable loading condition setting unit 17 to the optimization analysis model, performs the optimization analysis under the optimization analysis conditions, and leaves, as temporary optimal arrangement of the joining points, the arrangement of the joining candidate points to achieve any of reduction of the liner cumulative damage of the joining candidate points, improvement of the stiffness of the optimization analysis model, and minimization of the number of the joining candidate points to be left.

For the optimization analysis by the optimization analysis unit 34, the topology optimization can be applied similarly to the optimization analysis unit 23 of the first embodiment described above.

(Generation Unit for Analysis Object Model with Joining Candidate Points Selected and Set)

The generation unit 35 for analysis object model with joining candidate points selected and set selects a predetermined number of joining candidate points from among the joining candidate points remaining as the temporary optimal arrangement after the optimization analysis in the optimization analysis unit 34, sets the selected joining candidate points to the analysis object model instead of the initial joining points, and generates an analysis object model with joining candidate points selected and set.

In the topology optimization based on the densimetry, the density of the elements (e.g., beam element etc.) modeled as the joining candidate points is calculated, and therefore, the generation unit 35 for analysis object model with joining candidate points selected and set preferably selects, for example, a predetermined number of joining candidate points from joining candidate points having a density in the elements equal to or larger than a predetermined threshold and set to the analysis object model.

### (Performance Calculation Unit for Selected Joining Candidate Points)

The performance calculation unit 37 for selected joining candidate points performs stress analysis by applying the loading condition of each vibration pattern in the variable loading condition, and the constraint condition, which are set by the variable loading condition setting unit 17, to the analysis object model with joining candidate points selected and set, and uses a result of the stress analysis to calculate the fatigue life of the selected joining candidate points under the variable loading condition and the stiffness of the analysis object model with joining candidate points selected and set.

Similar to the target fatigue life setting unit 19 described above, the fatigue life under the variable loading condition of the joining candidate points set to the analysis object model with joining candidate points selected and set is preferably obtained by calculating the liner cumulative damage DM (see Formula (2)) on the basis of the linear cumulative damage rule by using the stress on the joining candidate points obtained by the stress analysis for the analysis object model with joining candidate points selected and set, and can be obtained by commercially available fatigue life prediction analysis software.

For the stress on the joining candidate points used for calculating the liner cumulative damage DM, for example, the stress on the two-dimensional element of the part model to which the beam elements modeled as the joining candidate points are connected, the nominal structure stress calculated from the force and moment acting on both ends of each beam element, or the like can be used.

In addition, for the stiffness of the analysis object model with joining candidate points selected and set, for example, a predetermined position can be used as the stiffness evaluation point and the displacement or strain thereof can be used as the index, and displacement of the stiffness evaluation point under the variable loading condition or a value obtained by dividing the variable amplitude load into the respective vibration patterns and adding the displacement of the stiffness evaluation point under the loading condition of each vibration pattern is preferably used as the index.

### (Determination Unit)

The determination unit 39 determines whether the fatigue life of the joining candidate points under the variable loading condition in the analysis object model with joining candidate points selected and set, and the stiffness of the analysis object model with joining candidate points selected and set satisfy the predetermined performance exceeding these of the analysis object model to which the initial joining points are set.

The predetermined performance related to the fatigue life is preferably, for example, within a predetermined range of the target fatigue life set by the target fatigue life setting unit 19.

### (Optimal Joining Point Determination Unit)

When the determination unit 39 determines that the predetermined performance is satisfied, the optimal joining point determination unit 41 determines the arrangement of the joining candidate points selected by the generation unit 35 for analysis object model with joining candidate points selected and set, as the optimal arrangement of the joining points, and when the determination unit 39 determines that the predetermined performance is not satisfied, the optimal joining point determination unit 41 changes, until the predetermined performance is satisfied, any of the conditions set by the optimization analysis condition setting unit 21, that is, the condition about the liner cumulative damage of joining candidate points to be left after the optimization analysis, the condition about the stiffness of the optimization analysis model, or the condition about the number of joining candidate points to be left after the optimization analysis, repeats processing by the optimization analysis unit 34, the generation unit 35 for analysis object model with joining candidate points selected and set, the performance calculation unit 37 for selected joining candidate points, and the determination unit 39, and determines the arrangement of the joining candidate points selected when the predetermined performance is satisfied is determined as the optimal arrangement of the joining points.

When it is determined that the stiffness and the fatigue life do not satisfy the predetermined performance by the determination unit 39, the optimal joining point determination unit 41 preferably changes, for example, the optimization analysis condition such as the threshold for selecting the joining candidate points by using the optimization analysis condition setting unit 21 so as to increase the number of joining candidate points to be left after the optimization analysis.

Note that when the condition about the liner cumulative damage of joining candidate points, the condition about the stiffness of the optimization analysis model, or the condition about the number of joining candidate points to be left are changed in the optimization analysis condition setting unit 21, any one of the conditions may be changed, or two or three conditions may be simultaneously changed.

### <Optimization Analysis Method for Joining Positions of Automotive Body>

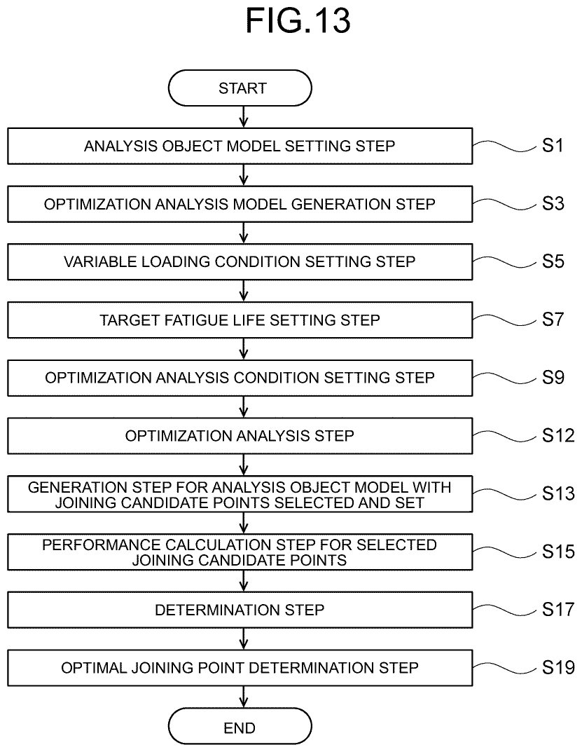

In the optimization analysis method for joining positions of an automotive body according to the second embodiment of the present invention, the optimization analysis for optimal arrangement of the joining points is performed in order to achieve any of improvement of stiffness of the automotive body model, improvement of fatigue life of the joining points of the automotive body model at which the parts assembly is joined, and minimization of the number of the joining points, through performance of the following steps by a computer, for the whole or part of the automotive body model of the automobile that includes a plurality of part models including the beam element, the two-dimensional element, and/or the three-dimensional element and that has the initial joining points at which the plurality of part models as the parts assembly is joined, and the method includes the analysis object model setting step S1, the optimization analysis model generation step S3, the variable loading condition setting step S5, the target fatigue life setting step S7, the optimization analysis condition setting step S9, an optimization analysis step S12, a generation step S13 for analysis object model with joining candidate points selected and set, a performance calculation step S15 for selected joining candidate points, a determination step S17, and an optimal joining point determination step S19, as illustrated in FIG. 13.

Among the above steps, the analysis object model setting step S1, the optimization analysis model generation step S3, the variable loading condition setting step S5, the target fatigue life setting step S7, and the optimization analysis condition setting step S9 are similar to those of the present first embodiment described above, and therefore, the optimization analysis step S12, the generation step S13 for analysis object model with joining candidate points selected and set, the performance calculation step S15 for selected joining candidate points, the determination step S17, and the optimal joining point determination step S19 will be described below. Note that the steps of the optimization analysis method according to the present second embodiment are performed by the optimization analysis apparatus 31 (FIG. 12) constituted by the computer.

### <<Optimization Analysis Step>>

In the optimization analysis step S12, the variable loading condition set in the variable loading condition setting step S5 is applied to the optimization analysis model, the optimization analysis under the optimization analysis conditions is performed, and the arrangement of the joining candidate points to achieve any of reduction of the liner cumulative damage of the joining candidate points, improvement of the stiffness of the optimization analysis model, and minimization of the number of the joining candidate points to be left is left as the temporary optimal arrangement of the joining points.

In the present second embodiment, in the optimization analysis step S12, the optimization analysis unit 34 performs the optimization analysis by using the joining candidate points set to the floor structure member model 111 as the objects of optimization, and leaves the arrangement of the joining candidate points 155 satisfying the optimization analysis condition as the temporary optimal arrangement of the joining points 157 as illustrated in FIG. 10.

<<Generation Step for Analysis Object Model with Joining Candidate Points Selected and Set>>

In the generation step S13 for analysis object model with joining candidate points selected and set, the predetermined number of joining candidate points are selected from among the joining candidate points remaining as the temporary optimal arrangement after the optimization analysis in the optimization analysis step S12, and the selected joining candidate points are set to the analysis object model instead of the initial joining points, and the analysis object model with joining candidate points selected and set is generated. In the present second embodiment, the generation step S13 for analysis object model with joining candidate points selected and set is performed by the generation unit 35 for analysis object model with joining candidate points selected and set.

### <<Performance Calculation Step for Selected Joining Candidate Points>>

In the performance calculation step S15 for selected joining candidate points, the stress analysis is performed by applying the loading condition of each vibration pattern in the variable loading condition, and the constraint condition, which are set in the variable loading condition setting step S5, to the analysis object model with joining candidate points selected and set, and a result of the stress analysis is used to calculate the fatigue life of the selected joining candidate points under the variable loading condition and the stiffness of the analysis object model with joining candidate points selected and set. In the present second embodiment, the performance calculation step S15 for selected joining candidate points is performed by the performance calculation unit 37 for selected joining candidate points.

### <<Determination Step>>

In the determination step S17, it is determined whether the fatigue life of the joining candidate points under the variable loading condition in the analysis object model with joining candidate points selected and set, and the stiffness of the analysis object model with joining candidate points selected and set satisfy the predetermined performance exceeding that of the analysis object model to which the initial joining points are set. In the present second embodiment, the determination step S17 is performed by the determination unit 39.

As described above, the predetermined performance related to the fatigue life is preferably, for example, within a predetermined range of the target fatigue life set by the target fatigue life setting unit 19.

### <<Optimal Joining Point Determination Step>>

In the optimal joining point determination step S19, when it is determined that the predetermined performance is satisfied in the determination step S17, the arrangement of the joining candidate points selected in the generation step S13 for analysis object model with joining candidate points selected and set is determined as the optimal arrangement of the joining points, and when it is determined that the predetermined performance is not satisfied in the determination step S17, any of the conditions set in the optimization analysis condition setting step S9, that is, the condition about the liner cumulative damage of joining candidate points to be left after the optimization analysis, the condition about the stiffness of the optimization analysis model, or the condition about the number of joining candidate points to be left after the optimization analysis is changed until the predetermined performance is satisfied, the optimization analysis step S12, the generation step S13 for analysis object model with joining candidate points selected and set, the performance calculation step S15 for selected joining candidate points, and the determination step S17 are repeated, and the arrangement of the joining candidate points selected when the predetermined performance is satisfied is determined as the optimal arrangement of the joining points. In the determination step S17, the predetermined performance is sometimes not satisfied because a large number of joining candidate points have the intermediate density and the performance is comprehensively determined. In the present second embodiment, the optimal joining point determination step S19 is performed by the optimal joining point determination unit 41.

Note that, when the condition about the liner cumulative damage of joining candidate points, the condition about the stiffness of the optimization analysis model, or the condition about the number of joining candidate points to be left are changed in the optimization analysis condition setting step S9, any one of the conditions may be changed, or two or three conditions may be simultaneously changed.

### <Optimization Analysis Program for Joining Positions of Automotive Body>

The second embodiment of the present invention can be configured as the optimization analysis program for joining positions of an automotive body that causes the respective units of the optimization analysis apparatus 31 for joining positions of an automotive body, constituted by the computer to perform functions. In other words, the optimization analysis program for joining positions of an automotive body according to the second embodiment of the present invention performs the optimization analysis to obtain optimal arrangement of the joining points to achieve any of improvement of stiffness of the automotive body model, improvement of fatigue life of the joining points of the automotive body model at which the parts assembly is joined, and minimization of the number of the joining points, for the whole or part of the automotive body model of the automobile serving as the analysis object model that includes a plurality of part models including the beam element, the two-dimensional element, and/or the three-dimensional element, and that has the initial joining points at which the plurality of part models as the parts assembly is joined. The program has a function to cause the computer to function as the analysis object model setting unit 13, the optimization analysis model generation unit 15, the variable loading condition setting unit 17, the target fatigue life setting unit 19, the optimization analysis condition setting unit 21, the optimization analysis unit 34, the generation unit 35 for analysis object model with joining candidate points selected and set, the performance calculation unit 37 for selected joining candidate points, the determination unit 39, and the optimal joining point determination unit 41, as illustrated in FIG. 12.

As described above, in the optimization analysis method, apparatus, and program for joining positions of an automotive body according to the present second embodiment, with no discretization in topology optimization based on the densimetry, the optimal arrangement of the joining points can be appropriately determined to achieve any of minimization of the number of joining candidate points, improvement of the stiffness of the analysis object model, and improvement of the fatigue life of the joining point at which the parts assembly is joined, for the automotive body to which a load changing with time is input, as in the actual traveling of the automobile.

Note that in the above description, the automotive body model obtained by modeling the entire automotive body has been acquired, and the floor structure member model as a part of the automotive body model has been set as the analysis object model. However, in the present invention, the entire automotive body model may be set as the analysis object model, or a portion of the automotive body model other than the floor structure member model may be set as the analysis object model. Furthermore, a partial automotive body model that is a part of the automotive body model may be acquired, and the acquired partial automotive body model may be set as the analysis object model.

In addition, in the above, the floor structure member model 111 in which 352 initial joining points 131 are set in advance at an interval of 60 mm has been described as an example, but the interval between and the number of initial joining points 131 are not limited thereto.

Furthermore, the description has been made of the initial joining points 131 set in advance to the floor structure member model 111 by the operator or other means. However, in the present invention, new initial joining points may be set by the operator, or additional initial joining points may be further set to the analysis object model to which the initial joining points have already been set, in the analysis object model setting unit or in the analysis object model setting step.

Note that in the present first embodiment, the loading condition and the constraint condition illustrated in FIGS. 2 and 4 have been set to the floor structure member model 111, on the assumption of application of a constant load (moment) such as twisted around the FR (front to rear) axis and the RL axis, but in the present invention, the variable loading condition and the constraint condition is preferably set appropriately on the assumption of application of the variable amplitude load acting on a portion of the automotive body as the analysis object or on an actual automotive body.

In the examples of the present first embodiment and the second embodiment, the target performance of the fatigue life of the joining candidate points has been set on the basis of the shortest fatigue life (minimum fatigue life) of an initial joining point set to the analysis object model.

However, in the present invention, it is preferable to calculate the fatigue life of the joining candidate points 155 in the optimization analysis model to which the additional joining points 153 are densely set (FIG. 5) to the initial joining points 131 before optimization analysis, determine the minimum fatigue life from among the calculated fatigue lives of the joining candidate points, and set the target fatigue life in the optimization analysis so as to satisfy the following relationship. (Minimum fatigue life of initial joining points)≤(target fatigue life of joining candidate points)≤(minimum fatigue life of joining candidate points in which joining points are densely set before optimization analysis).

Furthermore, in the above description, the optimization analysis has been performed using both the initial joining points and the additional joining points as the joining candidate points, but only the additional joining points may be used as the joining candidate points, without using the initial joining points as the object of the optimization analysis, obtaining the optimal arrangement of the joining points to be added to the initial joining points.

Furthermore, in the description of the above example, the optimization analysis condition has been set in which the number of joining candidate points is the same as the number of initial joining points, but the optimization analysis condition may be set in which the number of joining candidate points is different from that of the initial joining points.

Furthermore, in some cases, when the optimization analysis is performed by setting the initial joining points as the joining candidate points, the joining candidate points to be joined to the parts assembly disappear in the optimization analysis, the parts assembly is broken, and the optimization analysis cannot be performed. In such a case, at least one fixed joining point that is not the object of the optimization analysis is preferably provided in each parts assembly.

Here, for example, the fixed joining point may be freely selected from the initial joining points, or fixed joining candidate points being candidates for the fixed joining point may be set to separately perform the stress analysis or optimization analysis of the analysis object model so that a fixed joining point may be selected from the fixed joining candidate points on the basis of a result of the analysis.

Furthermore, in the above description, the fatigue life of the joining candidate points or the stiffness of the optimization analysis model has been used for the objective function, but the number of joining candidate points may be used as the objective function, and the fatigue life and the stiffness may be used as the constraints.

### First Example

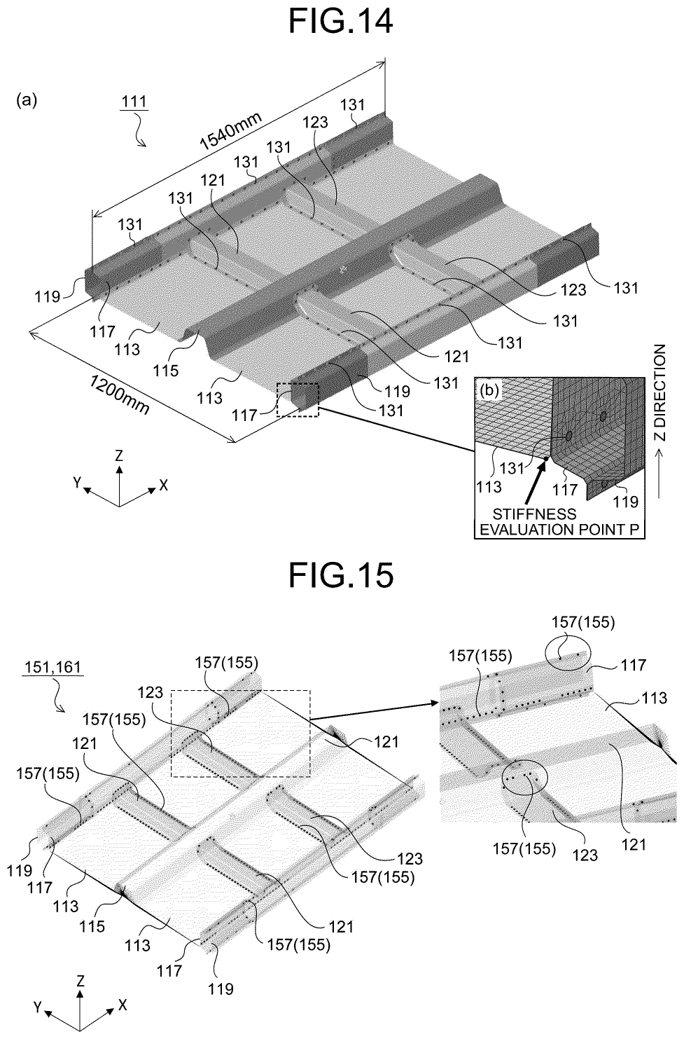

The analysis to confirm the effect of the present invention has been performed, and this analysis will be described. In the analysis, as illustrated in FIG. 14, the optimal arrangement of the joining points at which the part models constituting the floor structure member model 111 are joined as the parts assembly has been obtained by the optimization analysis, for the floor structure member model 111 obtained by modeling the floor of the automotive body.

As described in the first embodiment, the floor structure member model 111 includes, as the part models, the floor panel model 113, the floor tunnel member model 115, the locker inner model 117, the locker outer model 119, the front floor cross member model 121, and the rear floor cross member model 123. Each of these part models is obtained by modeling using the two-dimensional element.

Furthermore, in the floor structure member model 111, the initial joining points 131 at which the part models as the parts assembly are joined is set in advance. The initial joining points 131 were modeled using the beam elements connecting the nodes of the two-dimensional elements of the part models, the number of initial joining points were 352, and the interval P between the initial joining points 131 was 60 mm.

In the first example, first, the target fatigue life was set on the basis of the fatigue life of the initial joining points 131 under the variable loading condition shown in FIG. 6.

In the variable loading condition shown in FIG. 6, the combination of one cycle of input of an alternate moment of 0.7 kN·m around the FR axis as the loading condition of the first vibration pattern (FIG. 2) and next 20 cycles of an alternate moment of 1.4 kN·m around the RL axis as the loading condition of the second vibration pattern (FIG. 4) was defined as one sequence.

Next, the stress analysis of the floor structure member model 111 was performed for each of the loading condition of the first vibration pattern (FIG. 2) and the loading condition of the second vibration pattern (FIG. 4), and the stress generated at the initial joining points 131 under the loading condition of each vibration pattern was obtained.

Subsequently, the numbers of cycles N1 and N2 until the fracture of the initial joining points 131, during independent generation of different stress amplitudes σ1 and σ2 at the initial joining points 131 under the variable loading condition were obtained from the S—N curve (FIG. 7).

Then, the numbers of cycles N1 and N2 until fracture at the respective stress amplitudes and the numbers of cycles n1 (=1 cycle) and n2 (=20 cycles) of the loading condition of the first vibration pattern and loading condition of the second vibration pattern under the variable loading condition of one sequence were substituted in Formula (1) to obtain the liner cumulative damage dm per one sequence.

Furthermore, the number of sequences K when the liner cumulative damage DM calculated using Formula (2) was 1 or more was calculated as the fatigue life of the initial joining points 131 under the variable loading condition, and the target fatigue life was set on the basis of the shortest fatigue life of the fatigue life of the respective initial joining points.

After setting the target fatigue life, the optimization analysis of the optimal arrangement of the joining points in the floor structure member model 111 was performed. In the optimization analysis, first, as illustrated in FIG. 5, the optimization analysis model 151 was generated in which the additional joining points 153 were set at an interval p=20 mm between the initial joining points 131 in the floor structure member model 111 and the initial joining points 131 and the additional joining points 153 were densely set as the joining candidate points 155.

Next, the optimization analysis was performed by applying the loading conditions and the constraint condition illustrated in FIGS. 2 and 4, and the joining candidate points 155 satisfying the optimization analysis conditions were obtained. For the optimization analysis, the topology optimization based on the densimetry was applied, and the discretization was performed by setting the penalty coefficient to 20 in the topology optimization.

In the first example, as an inventive example, the objective function about the stiffness of the optimization analysis model 151, the constraint about the liner cumulative damage DM (fatigue life) of the joining candidate points 155 to be left after the optimization analysis, and the constraint about the number of joining candidate points 155 to be left after the optimization analysis were set as the optimization analysis conditions.

The objective function about the stiffness was set such that the displacement of the stiffness evaluation point P (see FIG. 14 (b)) obtained under each of the loading condition of the first vibration pattern and the loading condition of the second vibration pattern was equal to or less than the displacement of the stiffness evaluation point P obtained when the stress analysis was performed for the floor structure member model 111 in which the initial joining points 131 were set.

Furthermore, for the constraint about the fatigue life, the liner cumulative damage DM of the joining candidate points 155 under the variable loading condition was calculated, similarly to the initial joining points 131 described above. Then, it was assumed that the fatigue life calculated from the liner cumulative damage DM of each joining candidate point 155 was larger than the target fatigue life.

Furthermore, it was assumed that the constraint about the number of joining candidate points 155 was a condition that the number of joining candidate points to be left after the optimization analysis was set as the number of initial joining points 131.

Note that, in the first example, the optimization analysis condition was used, as a comparative example, in which the stiffness of the optimization analysis model was used for the objective function and only the number of joining candidate points was used for the constraint without giving the constraint about the liner cumulative damage DM (fatigue life), for comparison. Here, the condition about the stiffness and the condition about the number of joining candidate points in the comparative example were the same as those in the inventive example.

FIG. 10 illustrates a result of the remaining joining candidate points 155 in the inventive example, and FIG. 15 illustrates a result of the remaining joining candidate points 155 in the comparative example. Comparison between FIG. 10 and FIG. 15 shows a difference in characteristic of arrangement of the joining candidate points 155 between the inventive example and the comparative example mainly in a portion surrounded by a solid ellipse.

Furthermore, the arrangement of the joining candidate points 155 remaining after the optimization analysis was determined as the optimal arrangement of the joining points 157, and the stiffness and fatigue life of the joining points 157 were calculated for a floor structure member model 161 with optimal joining points in which optimal arrangement of the joining points 157 was set as illustrated in FIGS. 10 and 15.

In calculation of the stiffness and the fatigue life, first, the loading condition of the first vibration pattern illustrated in FIG. 2 and the loading condition of the second vibration pattern illustrated in FIG. 4, and the constraint condition were applied to the floor structure member model 161 with optimal joining points, and the stress analysis was performed.

For the stiffness of the floor structure member model 161 with optimal joining points, the displacement of the stiffness evaluation point P (see FIG. 14 (b)) obtained by the stress analysis under each of the loading condition of the first vibration pattern and the loading condition of the second vibration pattern was used as the index.

For the fatigue life of the joining points 157, the minimum fatigue life of the fatigue lives calculated using the stress on the joining points 157 obtained by the stress analysis of the floor structure member model 161 with optimal joining points was used as the index. In calculation of the fatigue life of the joining points 157, the two-dimensional element of the part model, to which the beam element obtained by modeling the joining point 157 having a nugget diameter of 5 mm was connected, was cut into web-shaped two-dimensional elements again (see FIG. 9).

Furthermore, also for the floor structure member model 111 (FIG. 14) in which the initial joining points 131 are set and the optimization analysis model 151 in which the initial joining points 131 and the additional joining points 153 are densely set before the optimization analysis as well, the stiffness and the minimum fatigue life were obtained and used as a standard example and a reference example, respectively.

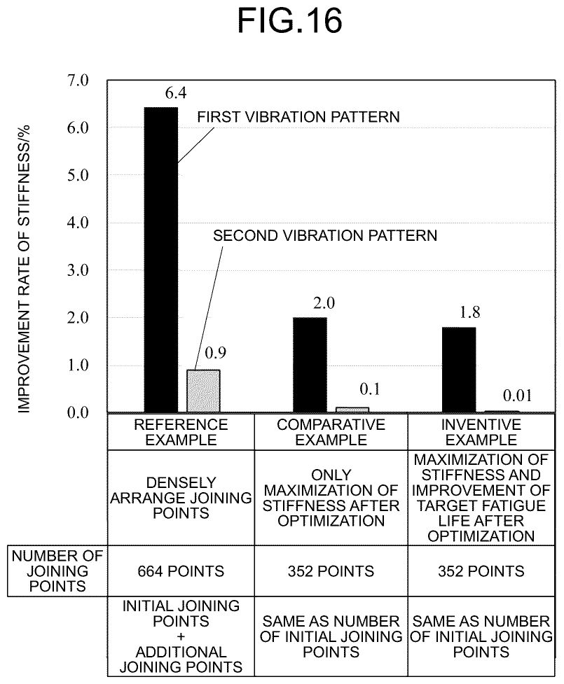

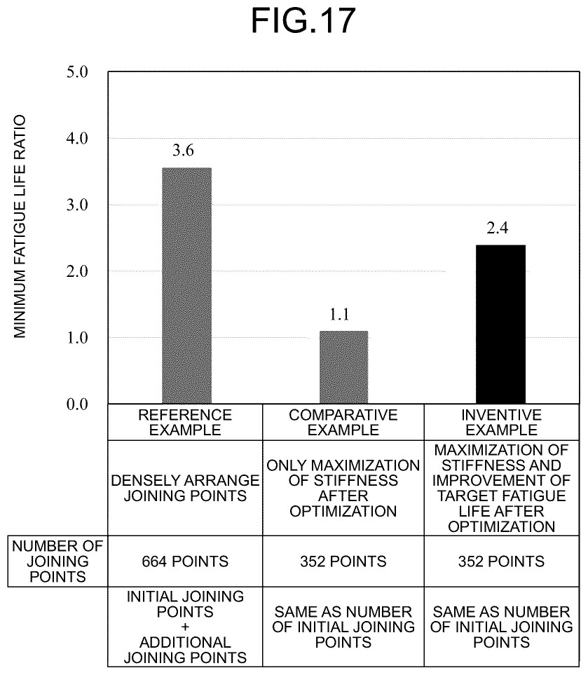

FIG. 16 illustrates results of the improvement rate of stiffness in the inventive example, the reference example, and the comparative example, and FIG. 17 illustrates results of minimum fatigue life ratios in the inventive example, the reference example, and the comparative example. Note that the improvement rate of stiffness in the inventive example and the comparative example was obtained on the basis of the displacement of the stiffness evaluation point P in the floor structure member model 111 of the standard example, and the minimum fatigue life ratio was represented as a ratio to the minimum fatigue life of the initial joining points 131 in the floor structure member model 111 of the standard example. Furthermore, in FIG. 16, a black bar graph indicates a result of the improvement rate of stiffness under the loading condition of the first vibration pattern, and a gray bar graph indicates a result of the improvement rate of stiffness under the loading condition of the second vibration pattern.

Both the inventive example and the comparative example showed a positive value in the improvement rate of stiffness, the stiffness was improved as compared with the standard example, and the minimum fatigue life was also improved. As illustrated in FIG. 16, the improvement rate of stiffness in the inventive example was 1.8%, which was slightly lower than 2.0% in the comparative example, but the stiffness was improved as compared with that in the standard example. Furthermore, as illustrated in FIG. 17, the minimum fatigue life ratio in the inventive example was 2.4, which was larger than the minimum fatigue life ratio (=1.1) in the comparative example, and was closer to the minimum fatigue life ratio (=3.6) in the reference example.

### Second Example

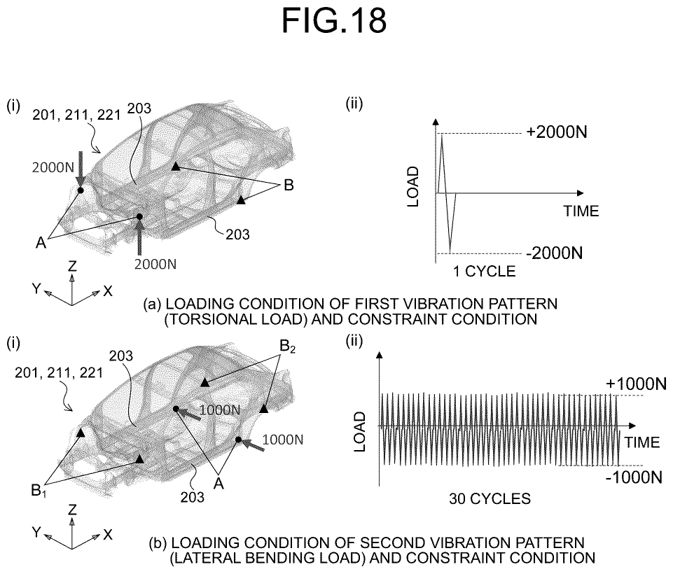

In the first example described above, optimization analysis of the joining points was performed for a part (floor portion) of the automotive body with stiffness as the objective function. However, in a second example, optimization analysis of the joining points in the automotive body model was performed for an automotive body model 201 being the entire automotive body (full vehicle model) illustrated in FIG. 18 by setting the condition about the liner cumulative damage (fatigue life) of the joining candidate points to be left after the optimization analysis, the condition about the stiffness of the optimization analysis model, and the condition about the number of joining candidate points to be left after the optimization analysis, as the objective functions or constraints as the optimization analysis conditions.

The automotive body model 201 includes a plurality of part models obtained by modeling body's frame parts and automobile panel parts by using the two-dimensional element, and the initial joining points at which the part models are joined as the parts assembly are set in advance. The number of initial joining points is 4983, and the initial joining points are modeled using the beam elements connecting the nodes of the two-dimensional elements of the part models.

First, the additional joining points were set between the initial joining points in the automotive body model 201 at a minimum joining point interval of 20 mm, the initial joining points and the additional joining points were densely set as the joining candidate points, and an optimization analysis model 211 (FIGS. 18 (a) (i) and 18 (b) (i)) was generated. Note that in the automotive body model 201, the joining point interval of the initial joining points is different for each parts assembly of the part models, and therefore, the joining point interval between the additional joining points set in the automotive body model 201 is not always constant. However, the additional joining points were set so as to be as uniform as possible and so as not to be less than the minimum joining point interval of 20 mm.

In the second example, first, a loading condition of a first vibration pattern illustrated in FIG. 18 (a) and a loading condition of a second vibration pattern illustrated in FIG. 18 (b) were combined to set the variable loading condition.

As illustrated in FIG. 18 (a), in the loading condition of the first vibration pattern, an alternate torsional load of ±2000 N is input in the vertical direction (Z direction) of the automotive body, with front suspension mounting positions on the left and right sides in the optimization analysis model 211 as the load input points (A in FIG. 18 (a) (i)), and in the constraint condition, rear portions of left and right side sills 203 of the optimization analysis model 211 are fully constrained as the constraint points (B in FIG. 18 (a) (i)).

As illustrated in FIG. 18 (b), in the loading condition of the second vibration pattern, an alternate lateral bending load of ±1000 N is input in a width direction of the automotive body (Y direction) with the rear portions 207 of the left and right side sills 203 of the optimization analysis model 211 as the load input points (A in FIG. 18 (b) (i)), and in the constraint condition, the front suspension mounting positions on the left and right sides of the automotive body model 201 are fully constrained as the constraint points (B1 in FIG. 18 (b) (i)), and translation is restrained with mounting positions between a rear sub-frame and the left and right sides of the body as the constraint points (B2 in FIG. 18 (b) (i)).

In the variable loading condition, a combination of the inputs of one cycle of the loading condition of the first vibration pattern (FIG. 18 (a)) and subsequent input of 30 cycles of the loading condition of the second vibration pattern (FIG. 18 (b)) was defined as one sequence.

Next, the stress analysis of the automotive body model 201 was performed for each of the loading condition of the first vibration pattern and the constraint condition (FIG. 18 (a)) and the loading condition of the second vibration pattern and the constraint condition (FIG. 18 (b)), and stress on the initial joining points under the loading conditions of the respective vibration patterns was obtained. In calculation of the stress on each of the initial joining points, a portion of the part model 143 to which the beam element 145 is connected was set on the basis of the nugget diameter of the actual spot welding point, the portion was cut into the web-shaped two-dimensional elements again, and the stress values of the two-dimensional elements in the peripheral portion 149 was used, as in the spot welding portion 141 illustrated in FIG. 9

Subsequently, the numbers of cycles N1 and N2 until the fracture of the initial joining points, during independent generation of different stress amplitudes σ1 and σ2 at the initial joining points under the variable loading condition were obtained from the S—N curve (FIG. 7).

Then, the numbers of cycles N1 and N2 until fracture at the respective stress amplitudes and the number of cycles n1 (=1 cycle) of the loading condition of the first vibration pattern and the number of cycles n2 (=30 cycles) of the loading condition of the second vibration pattern under the variable loading condition of one sequence were substituted in Formula (1) to obtain the liner cumulative damage dm per one sequence.

Furthermore, the number of sequences K when the liner cumulative damage DM calculated using Formula (2) was 1 or more was calculated as the fatigue life of the initial joining points under the variable loading condition, and the target fatigue life was set on the basis of the shortest fatigue life of the fatigue life of the respective initial joining points.

Then, the variable loading condition obtained by combining the loading condition of the first vibration pattern and the constraint condition, illustrated in FIG. 18 (a), and the loading condition of the second vibration pattern and the constraint condition, illustrated in FIG. 18 (b), was applied to the optimization analysis model 211 to perform optimization analysis, and the joining candidate points satisfying the optimization analysis conditions was obtained. For the optimization analysis, the topology optimization based on the densimetry was applied, and the discretization was performed by setting the penalty coefficient to 20 in the topology optimization.

In the second example, combinations of the objective functions and the constraints of the optimization analysis conditions shown in Table 1 were defined as an inventive example 21, an inventive example 22, and an inventive example 23.

TABLE 1

| | Inventive | Inventive | Inventive |
|---|---|---|---|
| | example 21 | example 22 | example 23 |
| Objective | Fatigue life | Stiffness | Number of |
| function | | | joining |
| | | | candidate |
| | | | points |
| Constraints | Stiffness | Fatigue life | Fatigue life |
| | Number of | Number of | Stiffness |
| | joining | joining | |
| | candidate | candidate | |
| | points | points | |

In the inventive example 21, the objective function about the fatigue life of the joining candidate points to be left after the optimization analysis, the constraint about the stiffness of the optimization analysis model 211, and the constraint about the number of joining candidate points to be left after the optimization analysis were set as the optimization analysis conditions. The objective function about the fatigue life was set on the condition that the fatigue life calculated from the liner cumulative damage DM of the joining candidate points exceeds the target fatigue life and has the maximum value. Furthermore, the constraint about the stiffness was set on the condition that an average value of the displacement of the left and right load input points A in the stress analysis in which the loading condition of the first vibration pattern and the loading condition of the second vibration pattern are applied to the optimization analysis model 211 is equal to or smaller than an average value of the displacement of the left and right load input points A obtained when the stress analysis is performed by applying the same loading condition to the original automotive body model 201. Furthermore, the constraint about the number of joining candidate points was set on the condition that the number of initial joining points (=4983 points) of the original automotive body model 201 is used.

In the inventive example 22, the objective function about the stiffness of the optimization analysis model 211, the constraint about the fatigue life of the joining candidate points to be left after the optimization analysis, and the constraint about the number of joining candidate points to be left after the optimization analysis were set as the optimization analysis conditions. The objective function about the stiffness was set on the condition that the sum of strain energy of the optimization analysis model 211 obtained when the stress analysis is performed by applying the loading condition of the first vibration pattern and the loading condition of the second vibration pattern to the optimization analysis model 211 is minimized. In addition, the constraint about the fatigue life was set on the condition that the fatigue life calculated from the liner cumulative damage DM of the joining candidate points exceeds the target fatigue life and has the maximum value. Furthermore, the constraint about the number of joining candidate points was set on the condition that the number of initial joining points (=4983 points) of the original automotive body model 201 is used.

In the inventive example 23, the objective function about the number of joining candidate points to be left after the optimization analysis, the constraint about the fatigue life of the joining candidate points to be left after the optimization analysis, and the constraint about the stiffness of the optimization analysis model 211 were set as the optimization analysis conditions. The objective function about the number of joining candidate points was set on the condition that the number of joining candidate points is minimized. Note that the joining candidate points that do not affect the stiffness performance or the fatigue life were not included in the objects of the optimization analysis. In addition, the constraint about the fatigue life was set on the condition that the fatigue life calculated from the liner cumulative damage DM of the joining candidate points exceeds the target fatigue life and has the maximum value. Furthermore, the constraint about the stiffness was set on the condition that the average value of the displacement of the left and right load input points A in the stress analysis in which the loading condition of the first vibration pattern and the loading condition of the second vibration pattern are applied to the optimization analysis model 211 is equal to or smaller than that of the original automotive body model 201.

Furthermore, the arrangement of the joining candidate points remaining after the optimization analysis was determined as the optimal arrangement of the joining points, and the stiffness and fatigue life of the joining points were calculated for an automotive body model 221 with optimum joining points in which optimal arrangement of the joining points was set as illustrated in FIG. 18. In calculation of the stiffness and the fatigue life, the loading condition of the first vibration pattern and the constraint condition, illustrated in FIG. 18 (a), and the loading condition of the second vibration pattern and the constraint condition, illustrated in FIG. 18 (b), were applied to the automotive body model 221 with optimum joining points with optimal joining points, and the stress analysis was performed.

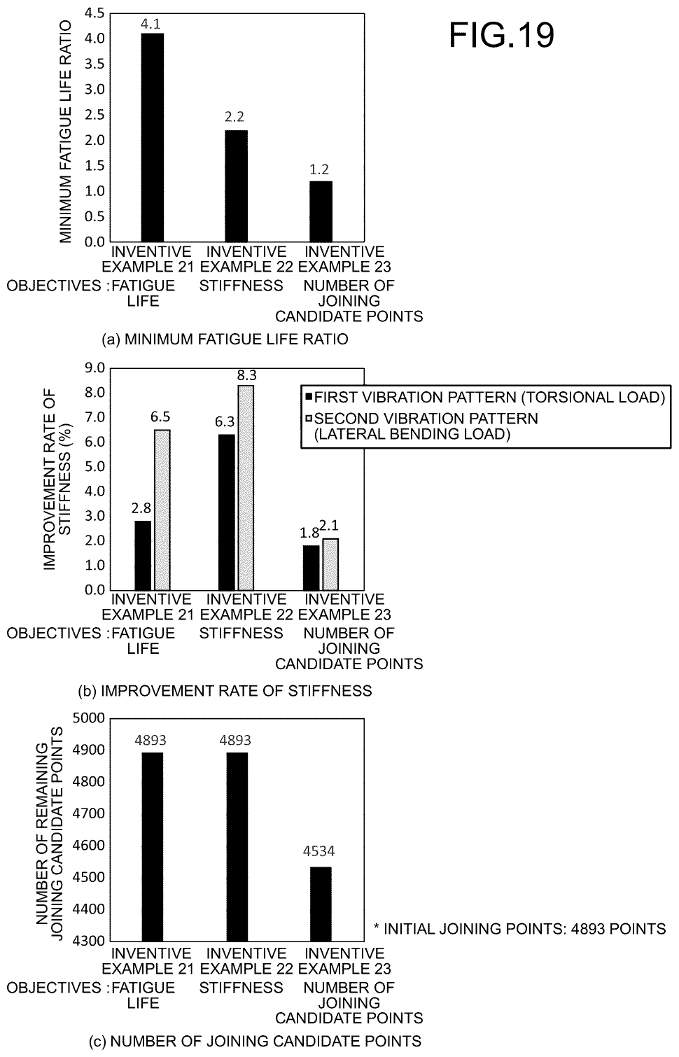

FIG. 19 illustrates the results of the minimum fatigue life ratio (FIG. 19 (a)), the improvement rate of stiffness (FIG. 19 (b)), and the number of remaining joining candidate points (FIG. 19 (c)) in the inventive example 21, inventive example 22, and inventive example 23. Furthermore, the results illustrated in FIG. 19 are collectively shown in Table 2.

TABLE 2

| | | Inventive | Inventive | Inventive |
|---|---|---|---|---|
| Results | | example 21 | example 22 | example 23 |
| Minimum fatigue | | 4.1 | 2.2 | 1.2 |
| life ratio (times) | | times | times | times |
| Improvement | Torsional load | 2.8% | 6.3% | 1.8% |
| rate of | Lateral | 6.5% | 8.3% | 2.1% |
| stiffness (%) | bending load | | | |

| | | | |
|---|---|---|---|
| Number of remaining joining | 4893 | 4893 | 4534 |
| candidate points | points | points | points |

In FIG. 19 and Table 2, the minimum fatigue life ratio of the automotive body model 221 with optimum joining points is shown as a ratio to the minimum fatigue life of the initial joining points in the original automotive body model 201. The improvement rate of stiffness of the automotive body model 221 with optimum joining points was obtained on the basis of the displacement of the stiffness evaluation points (load input points A) in the original automotive body model 201, and in FIG. 19 (b), a black bar graph represents the improvement rate of stiffness under the loading condition (torsional load) of the first vibration pattern, and a gray bar graph represents the result of the improvement rate of stiffness under the loading condition (lateral bending load) of the second vibration pattern.

In all of the inventive example 21, inventive example 22, and inventive example 23, the minimum fatigue life ratio of the automotive body model 221 with optimum joining points was improved, and the minimum fatigue life ratio in the inventive example 21 in which the fatigue life was used as the objective condition resulted in the highest result, 4.1 times.

In all of the inventive example 21, inventive example 22, and inventive example 23, the improvement rate of stiffness of the automotive body model 221 with optimum joining points has a positive value, and the stiffness was improved as compared with that of the original automotive body model 201. In particular, in the inventive example 22 in which the stiffness is set as the objective condition, the improvement rate of stiffness was 6.3% under the loading condition (torsional load) of the first vibration pattern and 8.3% under the loading condition (lateral bending load) of the second vibration pattern, both of which were higher than those in the inventive example 21 and inventive example 23.

Furthermore, in the inventive example 21 and inventive example 22, the number of joining points of the automotive body model 221 with optimum joining points is 4893 which is the same as the that of the original automotive body model 201, but in the inventive example 23 in which the number of joining candidate points is set as the objectives condition, the number of joining points can be reduced by 359 points (−7.3%) as compared with that of the original automotive body model.

### INDUSTRIAL APPLICABILITY

According to the present invention, it is possible to provide the optimization analysis method, apparatus, and program for joining positions of an automotive body that obtain optimal positions for joining points to minimize the number of the joining points while improving both of the stiffness of the automotive body of the automobile and fatigue life of the joining points in the automotive body at which the parts assembly is joined, upon input of variable amplitude load to the automotive body of the automobile.

### REFERENCE SIGNS LIST

1 OPTIMIZATION ANALYSIS APPARATUS
3 DISPLAY DEVICE
5 INPUT DEVICE
7 MEMORY STORAGE
9 WORKING DATA MEMORY
11 ARITHMETIC PROCESSING UNIT
13 ANALYSIS OBJECT MODEL SETTING UNIT
15 OPTIMIZATION ANALYSIS MODEL GENERATION UNIT
17 VARIABLE LOADING CONDITION SETTING UNIT
19 TARGET FATIGUE LIFE SETTING UNIT
21 OPTIMIZATION ANALYSIS CONDITION SETTING UNIT
23 OPTIMIZATION ANALYSIS UNIT
31 OPTIMIZATION ANALYSIS APPARATUS
33 ARITHMETIC PROCESSING UNIT
34 OPTIMIZATION ANALYSIS UNIT
35 GENERATION UNIT FOR ANALYSIS OBJECT MODEL WITH JOINING CANDIDATE POINTS SELECTED AND SET
37 PERFORMANCE CALCULATION UNIT FOR SELECTED JOINING CANDIDATE POINTS
39 DETERMINATION UNIT
41 OPTIMAL JOINING POINT DETERMINATION UNIT
101 AUTOMOTIVE BODY MODEL FILE
111 FLOOR STRUCTURE MEMBER MODEL
113 FLOOR PANEL MODEL
115 FLOOR TUNNEL MEMBER MODEL
117 LOCKER INNER MODEL
119 LOCKER OUTER MODEL
121 FRONT FLOOR CROSS MEMBER MODEL
123 REAR FLOOR CROSS MEMBER MODEL
125 FRONT END SURFACE PORTION
127 REAR END SURFACE PORTION
131 INITIAL JOINING POINT
141 SPOT WELDING PORTION
143 PART MODEL
145 BEAM ELEMENT
147 CENTER PORTION
149 PERIPHERAL PORTION
151 OPTIMIZATION ANALYSIS MODEL
153 ADDITIONAL JOINING POINT
155 JOINING CANDIDATE POINT
157 JOINING POINT
161 FLOOR STRUCTURE MEMBER MODEL WITH OPTIMAL JOINING POINTS
201 AUTOMOTIVE BODY MODEL
203 SIDE SILL
211 OPTIMIZATION ANALYSIS MODEL
221 AUTOMOTIVE BODY MODEL WITH OPTIMUM JOINING POINTS

1.-9. (canceled)

10. An optimization analysis method for joining positions of an automotive body for performing optimization analysis for optimal arrangement of joining points in order to achieve any of improvement of stiffness of an automotive body model, improvement of fatigue life of the joining points of the automotive body model at which parts assembly is joined, and minimization of number of the joining points, through performance of the following steps by a computer, for the whole or part of the automotive body model of an automobile including a plurality of part models including a beam element, a two-dimensional element, and/or a three-dimensional element and having initial joining points at which the plurality of part models as the parts assembly is joined, the method comprising:
an analysis object model setting step of setting a whole or part of the automotive body model as an analysis object model;
an optimization analysis model generation step of generating an optimization analysis model by densely setting all joining candidate points being candidates for the joining points optimally arranged, to the analysis object model;
a variable loading condition setting step of setting a variable loading condition by dividing a variable amplitude load applied to the optimization analysis model into loading conditions of a plurality of different vibration patterns, combining the predetermined numbers of cycles of the respective loading conditions of the respective vibration patterns, and forming one sequence;
a target fatigue life setting step of setting a target fatigue life of the optimization analysis model as number of sequences of the variable loading condition;
an optimization analysis condition setting step of obtaining number of cycles to failure of each of the joining candidate points for each of the loading conditions of the vibration patterns, obtaining the sum of ratios between the number of cycles and the number of cycles to failure of the loading condition of each vibration pattern as much as the number of sequences of the variable loading condition set in the target fatigue life setting step, as liner cumulative damage of each of the joining candidate points, and setting a condition about the liner cumulative damage of the joining candidate points to be left after optimization analysis, a condition about stiffness of the optimization analysis model, and a condition about number of joining candidate points to be left after optimization analysis, as objective functions or constraints that are optimization analysis conditions, in order to perform optimization analysis for the optimization analysis model; and
an optimization analysis step of:
applying the variable loading condition set in the variable loading condition setting step to the optimization analysis model, performing optimization analysis under the optimization analysis conditions, and obtaining, as the optimal arrangement of the joining points, arrangement of the joining candidate points to achieve any of reduction of the liner cumulative damage of the joining candidate points, improvement of the stiffness of the optimization analysis model, and minimization of the number of the joining candidate points to be left; or
applying the variable loading condition set in the variable loading condition setting step to the optimization analysis model, performing optimization analysis under the optimization analysis conditions, and leaving, as the temporary optimal arrangement of the joining points, arrangement of the joining candidate points to achieve any of reduction of the liner cumulative damage of the joining candidate points, improvement of the stiffness of the optimization analysis model, and minimization of the number of the joining candidate points to be left,
wherein in a case where the optimization analysis step leaves, as the temporary optimal arrangement of the joining points, the arrangement of the joining candidate points to achieve any of reduction of the liner cumulative damage of the joining candidate points, the improvement of the stiffness of the optimization analysis model, and the minimization of the number of the joining candidate points to be left, the method further comprises:
a generation step for analysis object model with joining candidate points selected and set of selecting predetermined number of joining candidate points from among the joining candidate points remaining as the temporary optimal arrangement after the optimization analysis, setting the selected joining candidate points to the analysis object model instead of the initial joining points, and generating an analysis object model with joining candidate points selected and set;
a performance calculation step for selected joining candidate points of performing stress analysis by applying the loading condition of each vibration pattern in the variable loading condition, and the constraint condition, which are set in the variable loading condition setting step, to the analysis object model with joining candidate points selected and set, and using a result of the stress analysis to calculate the fatigue life of the selected joining candidate points under the variable loading condition and the stiffness of the analysis object model with joining candidate points selected and set;
a determination step of determining whether the fatigue life of the joining candidate points under the variable loading condition in the analysis object model with joining candidate points selected and set, and the stiffness of the analysis object model with joining candidate points selected and set satisfy predetermined performance exceeding that of the analysis object model to which the initial joining points are set; and
an optimal joining point determination step of determining arrangement of the selected joining candidate points as optimal arrangement of the joining points when it is determined that the predetermined performance is satisfied in the determination step, and changing the condition about the liner cumulative damage of the joining candidate points to be left after optimization analysis, the condition about the stiffness of the optimization analysis model, or the condition about the number of joining candidate points to be left after the optimization analysis set in the optimization analysis condition setting step until the predetermined performance is satisfied, when it is determined that the predetermined performance is not satisfied in the determination step, repeating the optimization analysis step, the generation step for analysis object model with joining candidate points selected and set, the performance calculation step for selected joining candidate points, and the determination step, and determining the arrangement of the joining candidate points selected when the predetermined performance is satisfied, as the optimal arrangement of the joining points.

11. The optimization analysis method according to claim 10, wherein in the optimization analysis step, topology optimization based on densimetry is performed, and discretization is performed by setting a penalty coefficient to 4 or more in the topology optimization in a case where the optimization analysis step obtains, as the optimal arrangement of the joining points, the arrangement of the joining candidate points to achieve any of reduction of the liner cumulative damage of the joining candidate points, the improvement of the stiffness of the optimization analysis model, and the minimization of the number of the joining candidate points to be left.

12. An optimization analysis apparatus for joining positions of an automotive body, the apparatus performing optimization analysis to obtain optimal arrangement of joining points to achieve any of improvement of stiffness of an automotive body model, improvement of fatigue life of the joining points of the automotive body model at which parts assembly is joined, and minimization of number of the joining points, for the whole or part of the automotive body model of an automobile including a plurality of part models including a beam element, a two-dimensional element, and/or a three-dimensional element and having initial joining points at which the plurality of part models are joined as the parts assembly, the apparatus comprising:
an analysis object model setting unit configured to set the whole or part of the automotive body model as an analysis object model;
an optimization analysis model generation unit configured to generate an optimization analysis model by densely setting all joining candidate points being candidates for the joining points optimally arranged, to the analysis object model;
a variable loading condition setting unit configured to
set a variable loading condition by dividing a variable amplitude load applied to the optimization analysis model into loading conditions of a plurality of different vibration patterns,
combine the predetermined numbers of cycles of the respective loading conditions of the respective vibration patterns, and
form one sequence;
a target fatigue life setting unit configured to set a target fatigue life of the optimization analysis model as number of sequences of the variable loading condition;
an optimization analysis condition setting unit configured to
obtain number of cycles to failure of each of the joining candidate points for each of the loading conditions of the vibration patterns,
obtain the sum of ratios between the number of cycles and the number of cycles to failure of the loading condition of each vibration pattern as much as the number of sequences of the variable loading condition set in the target fatigue life setting unit, as liner cumulative damage of each of the joining candidate points, and
set a condition about the liner cumulative damage of the joining candidate points to be left after optimization analysis, a condition about stiffness of the optimization analysis model, and a condition about number of joining candidate points to be left after optimization analysis, as objective functions or constraints that are optimization analysis conditions, in order to perform optimization analysis for the optimization analysis model; and
an optimization analysis unit configured to:
apply the variable loading condition set in the variable loading condition setting unit to the optimization analysis model, performs optimization analysis under the optimization analysis conditions, and obtain, as the optimal arrangement of the joining points, arrangement of the joining candidate points to achieve any of reduction of the liner cumulative damage of the joining candidate points, improvement of the stiffness of the optimization analysis model, and minimization of the number of the joining candidate points to be left; or
apply the variable loading condition set in the variable loading condition setting unit to the optimization analysis model, performs optimization analysis under the optimization analysis conditions, and leave, as the temporary optimal arrangement of the joining points, arrangement of the joining candidate points to achieve any of reduction of the liner cumulative damage of the joining candidate points, improvement of the stiffness of the optimization analysis model, and minimization of the number of the joining candidate points to be left,
wherein in a case where the optimization analysis unit is configured to leave, as the temporary optimal arrangement of the joining points, arrangement of the joining candidate points to achieve any of reduction of the liner cumulative damage of the joining candidate points, improvement of the stiffness of the optimization analysis model, and minimization of the number of the joining candidate points to be left, the optimization analysis apparatus further comprises:
a generation unit for analysis object model with joining candidate points selected and set configured to
select a predetermined number of joining candidate points from among the joining candidate points remaining as the temporary optimal arrangement after the optimization analysis,
set the selected joining candidate points to the analysis object model instead of the initial joining points, and
generate an analysis object model with joining candidate points selected and set;
a performance calculation unit for selected joining candidate points configured to
perform stress analysis by applying the loading condition of each vibration pattern in the variable loading condition, and the constraint condition, which are set in the variable loading condition setting unit, to the analysis object model with joining candidate points selected and set, and
use a result of the stress analysis to calculate the fatigue life of the selected joining candidate points under the variable loading condition and the stiffness of the analysis object model with joining candidate points selected and set;
a determination unit configured to
determine whether the fatigue life of the joining candidate points under the variable loading condition in the analysis object model with joining candidate points selected and set, and the stiffness of the analysis object model with joining candidate points selected and set satisfy predetermined performance exceeding that of the analysis object model to which the initial joining points are set; and
an optimal joining point determination unit configured to
determine arrangement of the selected joining candidate points as optimal arrangement of the joining points when it is determined that the predetermined performance is satisfied by the determination unit, and
change the condition about the liner cumulative damage of the joining candidate points to be left after optimization analysis, the condition about the stiffness of the optimization analysis model, or the condition about the number of joining candidate points to be left after the optimization analysis set in the optimization analysis condition setting unit until the predetermined performance is satisfied, when it is determined that the predetermined performance is not satisfied by the determination unit, repeats processing by the optimization analysis unit, the generation unit for analysis object model with joining candidate points selected and set, the performance calculation unit for selected joining candidate points, and the determination unit, and determines the arrangement of the joining candidate points selected when the predetermined performance is satisfied, as the optimal arrangement of the joining points.

13. The optimization analysis apparatus for joining positions of an automotive body according to claim 12, wherein the optimization analysis unit performs topology optimization based on densimetry, and performs discretization by setting a penalty coefficient to 4 or more in the topology optimization.

14. A non-transitory computer-readable recording medium on which an executable program for joining positions of an automotive body, the program performing optimization analysis to obtain optimal arrangement of joining points to achieve any of improvement of stiffness of an automotive body model, improvement of fatigue life of the joining points of the automotive body model at which parts assembly is joined, and minimization of number of the joining points, for the whole or part of the automotive body model of an automobile including a plurality of part models including a beam element, a two-dimensional element, and/or a three-dimensional element and having initial joining points at which the plurality of part models are joined as the parts assembly, the program causing a processor of a computer to execute the steps of:
(a) setting a whole or part of the automotive body model as an analysis object model;
(b) generating an optimization analysis model by densely setting all joining candidate points being candidates for the joining points optimally arranged, to the analysis object model;
(c) setting a variable loading condition by dividing a variable amplitude load applied to the optimization analysis model into loading conditions of a plurality of different vibration patterns, combining the predetermined numbers of cycles of the respective loading conditions of the respective vibration patterns, and forming one sequence;
(d) setting a target fatigue life of the optimization analysis model as number of sequences of the variable loading condition;
(e) obtaining number of cycles to failure of each of the joining candidate points for each of the loading conditions of the vibration patterns, obtaining the sum of ratios between the number of cycles and the number of cycles to failure of the loading condition of each vibration pattern as much as the number of sequences of the variable loading condition set in the target fatigue life setting unit, as liner cumulative damage of each of the joining candidate points, and setting a condition about the liner cumulative damage of the joining candidate points to be left after optimization analysis, a condition about stiffness of the optimization analysis model, and a condition about number of joining candidate points to be left after optimization analysis, as objective functions or constraints that are optimization analysis conditions; and
(f1) applying the variable loading condition set in the variable loading condition setting unit to the optimization analysis model, performing optimization analysis under the optimization analysis conditions, and obtaining, as the optimal arrangement of the joining points, arrangement of the joining candidate points to achieve any of reduction of the liner cumulative damage of the joining candidate points, improvement of the stiffness of the optimization analysis model, and minimization of the number of the joining candidate points to be left, or
(f2) applying the variable loading condition set in the variable loading condition setting unit to the optimization analysis model, performing optimization analysis under the optimization analysis conditions, and leaving, as the temporary optimal arrangement of the joining points, arrangement of the joining candidate points to achieve any of reduction of the liner cumulative damage of the joining candidate points, improvement of the stiffness of the optimization analysis model, and minimization of the number of the joining candidate points to be left,
Wherein in a case where the program causes the processor to execute the step (f2), the program further causes the processor to execute:
(g) selecting a predetermined number of joining candidate points from among the joining candidate points remaining as the temporary optimal arrangement after the optimization analysis, setting the selected joining candidate points to the analysis object model instead of the initial joining points, and generating an analysis object model with joining candidate points selected and set;
(h) performing stress analysis by applying the loading condition of each vibration pattern in the variable loading condition, and the constraint condition, which are set in the variable loading condition setting unit, to the analysis object model with joining candidate points selected and set, and using a result of the stress analysis to calculate the fatigue life of the selected joining candidate points under the variable loading condition and the stiffness of the analysis object model with joining candidate points selected and set;
(i) determining whether the fatigue life of the joining candidate points under the variable loading condition in the analysis object model with joining candidate points selected and set, and the stiffness of the analysis object model with joining candidate points selected and set satisfy predetermined performance exceeding that of the analysis object model to which the initial joining points are set; and
(j) when it is determined that the predetermined performance is satisfied, determining arrangement of the selected joining candidate points as optimal arrangement of the joining points,
(k) when it is determined that the predetermined performance is not satisfied, changing the condition about the set liner cumulative damage of the joining candidate points to be left after optimization analysis, the condition about the stiffness of the optimization analysis model, or the condition about the number of joining candidate points to be left after the optimization analysis until the predetermined performance is satisfied, repeating the steps (f2) to (i), and determining the arrangement of the joining candidate points selected when the predetermined performance is satisfied, as the optimal arrangement of the joining points.

15. The non-transitory computer-readable recording medium according to claim 14, wherein the program further causes the processor to execute:
performing topology optimization based on densimetry; and
performing discretization by setting a penalty coefficient to 4 or more in the topology optimization.
